(19) United States
(12) Patent Application Publication
(10) Pub. No.: US 2024/0248765 A1
(43) Pub. Date: Jul. 25, 2024

(54) INTEGRATED PLATFORM GRAPHICAL USER INTERFACE CUSTOMIZATION

(71) Applicant: Luxury Presence, Inc., West Hollywood, CA (US)

(72) Inventors: Thomas Scanlan, Chicago, IL (US); Dawn McKenna, Burr Ridge, IL (US); Micheal Anthony, Hinsdale, IL (US)

(73) Assignee: Luxury Presence, Inc., West Hollywood, CA (US)

(21) Appl. No.: 18/414,537

(22) Filed: Jan. 17, 2024

Related U.S. Application Data
(60) Provisional application No. 63/480,724, filed on Jan. 20, 2023.

(51) Int. Cl. G06F 9/50; G06F 9/54

(52) U.S. Cl. CPC G06F 9/5038; G06F 9/541

(57) ABSTRACT

Systems and methods initiate displaying a first GUI of an integrated platform that interconnects transfer source(s) and transfer destination(s), wherein access to the integrated platform is restricted to registered users, and end user data of at least one of the transfer destination(s) are at least partially obtained from user responses to system prompts displayed via the first GUI and from user activities of user(s) of the transfer destination(s). End user data is applied to a deployed AI model to identify resource(s) available for transfer to generate a listing of the resource(s), and a probability score indicating a likelihood the user(s) will be interested is assigned to the resource(s) and sorted to prioritize highest scored resources. Display of a customized second GUI including the listing of the resource(s) is initiated.

### TECHNICAL FIELD

The systems and methods disclosed herein implement a technology platform that interconnects disparate system users and integrates, optimizes, and customizes workflow management utilizing artificial intelligence and natural language processing technology.

### BACKGROUND

Complex resource, product, property, or service transactions commonly include a transfer source (e.g., a seller), a transfer destination (e.g., a buyer), as well as one or more intermediaries that facilitate the transaction (e.g., an agent). The transfer source, transfer destination, and agents are typically interconnected through multiple disparate systems without a centralized or consistent workflow management. Further, the transactions may rely on data from disparate systems that are decentralized and must be individually accessed and assessed by system users. Assessments often rely on subjective factors that are not standardized, such as agent experience or intuition. Some technology platforms have been developed to facilitate simple transactions involving low resources values that do not require intermediaries, but such systems are unable to facilitate complex transactions that require third parties, disparate communication systems, and decentralized data resources.

The systems and methods disclose herein overcome the drawbacks of existing techniques and technology by providing an integrated platform that interconnects transfer sources, transfer destinations, intermediaries, and third party data sources. The technology platform implements a customizable, optimized workflow through artificial intelligence, machine learning, and natural language processing technologies.

### SUMMARY

Shortcomings of the prior art are overcome and additional advantages are provided through the provision of a computing system for integrated platform graphical user interface customization. The computing system includes at least one processor, a communication interface communicatively coupled to the at least one processor, and a memory device storing executable code that, when executed, causes the at least one processor to, at least in part, initiate displaying, via a display of a user computing device, a first GUI of an integrated platform that interconnects one or more transfer sources and one or more transfer destinations, wherein access to the integrated platform is restricted to registered users. Further, end user data are of at least one transfer destination of the one or more transfer destinations are obtained, where the end user data are at least partially obtained from user responses to system prompts displayed via the first GUI and also from user activities of one or more users of the at least one transfer destination. The end user data are applied to a deployed artificial intelligence model to identify one or more resources available for transfer from the one or more transfer sources to the one or more transfer destinations, the applying generating a listing of the one or more resources available. Based on the identified one or more resources, a probability score is assigned to each of the one or more resources, the probability score indicating a likelihood that the one or more users of the at least one transfer destination will be interested in the one or more resources. The listing of the one or more resources is sorted in accordance with the assigned probability score such that highest scored resources are prioritized, and display, via the display of the user computing device, of a customized second GUI that includes the listing of the one or more resources is initiated.

Also disclosed is a computing system that includes at least one processor, a communication interface communicatively coupled to the at least one processor, and a memory device storing executable code that, when executed, causes the at least one processor to, at least in part, initiate displaying, via a display of a user computing device, a first GUI of an integrated platform that interconnects one or more transfer sources and one or more transfer destinations, wherein access to the integrated platform is restricted to registered users. A request is received from the user computing device to access a series of Create Work Flow GUIs used to initiate a work flow of a transfer of a resource of one or more resources available for transfer via the integrated platform, the series of Create Work Flow GUIs facilitating data entry related to the transfer, wherein data to be entered via the Create Work Flow GUIs includes at least one selected from the group consisting of (i) a resource location, (ii) a duration for completing the work flow, (iii) motivation data characterizing an underlying reason for initiating the transfer; and (iv) characterization data characterizing the resource. Further, the system initiates displaying, via the user computing device, the requested series of Create Work Flow GUIs to facilitate effectuation of the transfer.

Also disclosed is a computer-implemented method that includes, at least in part, initiating displaying, via a display of a user computing device, a first GUI of an integrated platform that interconnects one or more transfer sources and one or more transfer destinations, wherein access to the integrated platform is restricted to registered users. Further, end user data are of at least one transfer destination of the one or more transfer destinations are obtained, where the end user data are at least partially obtained from user responses to system prompts displayed via the first GUI and also from user activities of one or more users of the at least one transfer destination. The end user data are applied to a deployed artificial intelligence model to identify one or more resources available for transfer from the one or more transfer sources to the one or more transfer destinations, the applying generating a listing of the one or more resources available. Based on the identified one or more resources, a probability score is assigned to each of the one or more resources, the probability score indicating a likelihood that the one or more users of the at least one transfer destination will be interested in the one or more resources. The listing of the one or more resources is sorted in accordance with the assigned probability score such that highest scored resources are prioritized, and display, via the display of the user computing device, of a customized second GUI that includes the listing of the one or more resources is initiated.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION OF THE DRAWINGS

Features, aspects, and advantages of the present invention are better understood when the following detailed description of the invention is read with reference to the accompanying figures, in which:

FIG. 1 is an example system diagram according to one embodiment.

FIG. 2A is a diagram of a feedforward network, according to at least one embodiment, utilized in machine learning.

FIG. 2B is a diagram of a convolution neural network, according to at least one embodiment, utilized in machine learning.

FIG. 2C is a diagram of a portion of the convolution neural network of FIG. 2B, according to at least one embodiment, illustrating assigned weights at connections or neurons.

FIG. 3 is a diagram representing an example weighted sum computation in a node in an artificial neural network.

FIG. 4 is a diagram of a Recurrent Neural Network RNN, according to at least one embodiment, utilized in machine learning.

FIG. 5 is a schematic logic diagram of an artificial intelligence program including a front-end and a back-end algorithm.

FIG. 6 is a flow chart representing a method model development and deployment by machine learning.

FIG. 7 is a diagram of system functionality according to one embodiment.

FIG. 8 is a diagram of system functionality according to one embodiment.

FIG. 9A is an example Graphical User Interface according to one embodiment for accepting user preference data.

FIG. 9B is an example Graphical User Interface according to one embodiment for accepting user preference data.

FIG. 9C is an example Graphical User Interface according to one embodiment for accepting user preference data.

FIG. 10A is an example Graphical User Interface according to one embodiment for conducting a graphical search.

FIG. 10B is an example Graphical User Interface according to one embodiment for conducting a graphical search.

FIG. 11 is an example Graphical User Interface according to one embodiment for viewing property data.

FIG. 12 is an example Graphical User Interface according to one embodiment for viewing property data.

FIG. 13 is an example Graphical User Interface according to one embodiment for annotating property data.

FIG. 14 is an example Graphical User Interface according to one embodiment for facilitating and displaying data relating to the integration of end users to a property evaluation.

FIG. 15 is an example Graphical User Interface according to one embodiment for interconnecting system end users and sharing data.

FIG. 16 is an example Graphical User Interface according to one embodiment for displaying property data and database information relating to scheduled property evaluations.

FIG. 17A is an example Graphical User Interface according to one embodiment for displaying system notification and interconnecting end users, among other functions.

FIG. 17B is an example Graphical User Interface according to one embodiment for displaying system notification and interconnecting end users, among other functions.

FIG. 18 is an example Graphical User Interface according to one embodiment for displaying user preferences data and initiating a search utilizing user preference data.

FIG. 19A is an example Graphical User Interface according to one embodiment for workflow management.

FIG. 19B is an example Graphical User Interface according to one embodiment for workflow management.

FIG. 20A is an example Graphical User Interface according to one embodiment for initiating a transaction workflow according to customizable settings.

FIG. 20B is an example Graphical User Interface according to one embodiment for initiating a transaction workflow according to customizable settings.

FIG. 20CA is an example Graphical User Interface according to one embodiment for initiating a transaction workflow according to customizable settings.

FIG. 20D is an example Graphical User Interface according to one embodiment for initiating a transaction workflow according to customizable settings.

FIG. 21A is an example Graphical User Interface according to one embodiment for virtual staging.

FIG. 21A is an example Graphical User Interface according to one embodiment for virtual staging.

FIG. 22A is an example Graphical User Interface according to one embodiment for publishing property data to a third party online platform.

FIG. 22B is an example Graphical User Interface according to one embodiment for publishing property data to a third party online platform.

FIG. 23A is an example Graphical User Interface according to one embodiment for assessing analytics data.

FIG. 23B is an example Graphical User Interface according to one embodiment for assessing analytics data.

FIG. 23C is an example Graphical User Interface according to one embodiment for assessing analytics data.

FIG. 23D is an example Graphical User Interface according to one embodiment for assessing analytics data.

FIG. 24A is an example Graphical User Interface according to one embodiment for displaying a customizable data feed.

FIG. 24B is an example Graphical User Interface according to one embodiment for displaying a customizable data feed.

FIG. 25 is a block diagram of an example method for integrated platform graphical user interface customization, according to one embodiment.

FIG. 26 is a block diagram of an example method, according to one embodiment.

### DETAILED DESCRIPTION

The present invention will now be described more fully hereinafter with reference to the accompanying drawings in which example embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

It will be understood that relative terms are intended to encompass different orientations or sequences in addition to the orientations and sequences depicted in the drawings and described herein. Relative terminology, such as “substantially” or “about,” describe the specified devices, materials, transmissions, steps, parameters, or ranges as well as those that do not materially affect the basic and novel characteristics of the claimed inventions as whole (as would be appreciated by one of ordinary skill in the art).

The terms “coupled,” “fixed,” “attached to,” “communicatively coupled to,” “operatively coupled to,” and the like refer to both: (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

The term “user” is used interchangeably with the terms end user, client, buyer, seller, customer, or consumer and represents individuals who utilize software and system services offered by a provider to search for, evaluate, analyze, acquire, transfer, or otherwise convey an interest in tangible or intangible property, products, or services. The term user can also denote an agent utilizing the system to render services to a client in connection with searching for, evaluating, analyzing, acquiring, transferring, or facilitating the conveyance of an interest in tangible or intangible property, products, or services. The term “provider” describes a person or enterprise that establishes and/or maintains computer systems and software that implement the systems and methods described herein, which include offering computer system technology used in connection with searching for, evaluating, analyzing, acquiring, transferring, or facilitating the conveyance of an interest in tangible or intangible property, products, or services.

Embodiments are described with reference to flowchart illustrations or block diagrams of methods or apparatuses where each block or combinations of blocks can be implemented by computer-readable instructions (i.e., software). The term apparatus includes systems and computer program products. The referenced computer-readable software instructions may be provided to a processor of a general purpose computer, special purpose computer, or other programmable data processing apparatus to produce a particular machine. The instructions, which execute via the processor of the computer or other programmable data processing apparatus, create mechanisms for implementing the functions specified in this specification and attached figures.

The computer-readable instructions are loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the attached flowchart(s) or block diagram(s). Alternatively, computer software implemented steps or acts may be combined with operator or human implemented steps or acts in order to carry out an embodiment of the disclosed systems and methods.

The computer-readable software instructions may also be stored in a computer-readable memory that can direct a computer or other programmable data processing apparatus to function in a particular manner. In this manner, the instructions stored in the computer-readable memory produce an article of manufacture that includes the instructions, which implement the functions described and illustrated herein.

The terms “software application” or “application” is intended to generally refer to end user managed software (e.g., mobile apps, word processing software, email interface, etc.) as well as software services managed for users and used by software applications (e.g., background software processes that interface with an operating system and various software applications or automated software having no user interface). Software applications may incorporate on one or more “software processes” or “software modules” that perform discrete tasks in furtherance of the overall operations performed by a software application. The terms “software platform,” “technology platform,” or “platform” is used to refer generally to a collection of related software applications, software processes, software modules, and/or software services that perform operations and functions directed to accomplishing a related set of objectives.

The embodiments discussed in this specification are described with reference to systems and methods utilized in connection with the sale, lease, or other conveyance of an interest in real property. However, those of ordinary skill in the art will appreciate that the disclosed systems and methods are not limited to use in connection with real estate transactions. Rather, the systems and methods are generally applicable in other contexts where users or other customers interface with agents to search, evaluate, analyze, and acquire tangible or intangible property, products, or services.

### System Level Description

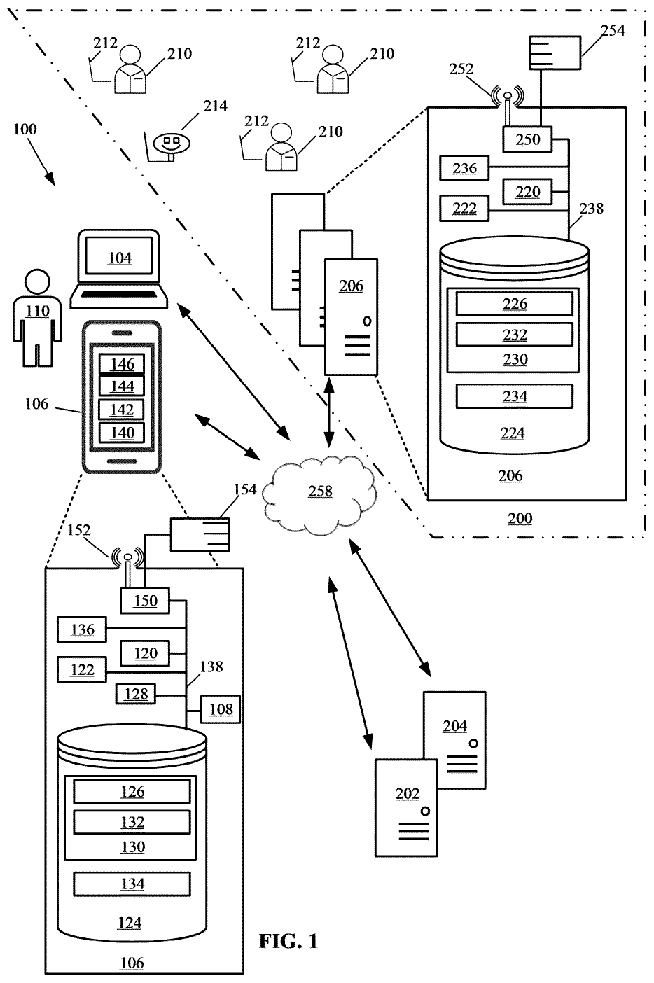

As shown in FIG. 1, a hardware system 100 configuration according to one embodiment generally includes a user 110 that benefits through use of services and products offered by a software service provider through an enterprise system 200. The user 110 accesses services and products by use of one or more user computing devices 104 & 106. The user computing device can be a larger device, such as a laptop or desktop computer 104, or a mobile computing device 106, such as smart phone or tablet device with processing and communication capabilities. The user computing device 104 & 106 includes integrated software applications that manage device resources, generate user interfaces, accept user inputs, and facilitate communications with other devices, among other functions. The integrated software applications can include an operating system, such as Linux®, UNIX®, Windows®, macOS®, iOS®, Android®, or other operating system compatible with personal computing devices.

The user 110 can be an individual, a group, or an entity having access to the user computing device 104 & 106. Although the user 110 is singly represented in some figures, at least in some embodiments, the user 110 is one of many, such as a market or community of users, consumers, customers, buyers, sellers, agents, business entities, and groups of any size.

The user computing device includes subsystems and components, such as a processor 120, a memory device 122, a storage device 124, or power system 128. The memory device 122 can be transitory random access memory (“RAM”) or read-only memory (“ROM”). The storage device 124 includes at least one of a non-transitory storage medium for long-term, intermediate-term, and short-term storage of computer-readable instructions 126 for execution by the processor 120. For example, the instructions 126 can include instructions for an operating system and various integrated applications or programs 130 & 132. The storage device 124 can store various other data items 134, including, without limitation, cached data, user files, pictures, audio and/or video recordings, files downloaded or received from other devices, and other data items preferred by the user, or related to any or all of the applications or programs.

The memory device 122 and storage device 124 are operatively coupled to the processor 120 and are configured to store a plurality of integrated software applications that comprise computer-executable instructions and code executed by the processing device 120 to implement the functions of the user computing device 104 & 106 described herein. Example applications include a conventional Internet browser software application and a mobile software application created by the provider to facilitate interaction with the provider system 200.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (“GUI”) on the display 140 that allows the user 110 to communicate with the mobile device 106, and, for example a mobile banking system, and/or other devices or systems. In one embodiment, the user 110 downloads or otherwise obtains the mobile system client application from a provider system or a third party platform that offers software for sale, license, and download. In other embodiments, the user 110 interacts with a provider system via a web browser application in addition to, or instead of, the mobile P2P payment system client application.

The integrated software applications also typically provide a graphical user interface (“GUI”) on the user computing device display screen 140 that allows the user 110 to utilize and interact with the user computing device. Example GUI display screens are depicted in the attached figures. The GUI display screens may include features for displaying information and accepting inputs from users, such as text boxes, data fields, hyperlinks, pull down menus, check boxes, radio buttons, and the like. One of ordinary skill in the art will appreciate that the example functions and user-interface display screens shown in the attached figures are not intended to be limiting, and an integrated software application may include other display screens and functions.

The processing device 120 performs calculations, processes instructions for execution, and manipulates information. The processing device 120 executes machine-readable instructions stored in the storage device 124 and/or memory device 122 to perform methods and functions as described or implied herein. The processing device 120 can be implemented as a central processing unit (“CPU”), a microprocessor, a graphics processing unit (“GPU”), a microcontroller, an application-specific integrated circuit (“ASIC”), a programmable logic device (“PLD”), a digital signal processor (“DSP”), a field programmable gate array (“FPGA”), a state machine, a controller, gated or transistor logic, discrete physical hardware components, and combinations thereof. In some embodiments, particular portions or steps of methods and functions described herein are performed in whole or in part by way of the processing device 120. In other embodiments, the methods and functions described herein include cloud-based computing such that the processing device 120 facilitates local operations, such communication functions, data transfer, and user inputs and outputs.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120.

The input and output system 136 may also include a touch screen display 140 that serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

The user computing device 104 & 106 may also include a positioning device 108, such as a global positioning system device (“GPS”) that determines a location of the user computing device. In other embodiments, the positioning device 108 includes a proximity sensor or transmitter, such as an RFID tag, that can sense or be sensed by devices proximal to the user computing device 104 & 106. In some embodiments, the user computing device 106 includes gyro sensors or accelerometers to detect movement, acceleration, and changes in positioning of the user computing device 106.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

A system intraconnect 138, such as a bus system, connects various components of the mobile device 106. The user computing device 104 & 106 further includes a communication interface 150. The communication interface 150 facilitates transactions with other devices and systems to provide two-way communications and data exchanges through a wireless communication device 152 or wired connection 154. Communications may be conducted via various modes or protocols, such as through a cellular network, wireless communication protocols using IEEE 802.11 standards. Communications can also include short-range protocols, such as Bluetooth or Near-field communication protocols. Communications may also or alternatively be conducted via the connector 154 for wired connections such by USB, Ethernet, and other physically connected modes of data transfer.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human representatives 210 act on behalf of the provider, such as customer service representatives, advisors, managers, and sales team members.

Provider representatives 210 utilize representative computing devices 212 to interface with the provider system 200. The representative computing devices 212 can be, as non-limiting examples, computing devices, kiosks, terminals, smart devices such as phones, and devices and tools at customer service counters and windows at POS locations. In at least one example, the diagrammatic representation and above-description of the components of the user computing device 104 & 106 in FIG. 1 applies as well to the representative computing devices 212. As used herein, the general term “end user computing device” can be used to refer to either the representative computing device 212 or the user computing device 110 depending on whether the representative (as an employee or affiliate of the provider) or the user (as a customer or consumer) is utilizing the disclosed systems and methods.

A computing system 206 of the enterprise system 200 may include components, such as a processor device 220, an input-output system 236, an intraconnect bus system 238, a communication interface 250, a wireless device 252, a hardwire connection device 254, a transitory memory device 222, and a non-transitory storage device 224 for long-term, intermediate-term, and short-term storage of computer-readable instructions 226 for execution by the processor device 220. The instructions 226 can include instructions for an operating system and various software applications or programs 230 & 232. The storage device 224 can store various other data 234, such as cached data, files for user accounts, user profiles, and transaction histories, files downloaded or received from other devices, and other data items required or related to the applications or programs 230 & 232.

The network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations.

The network 258 may be or include an enterprise or secured network, or may be implemented, at least in part, through one or more connections to the Internet. A portion of the network 258 may be a virtual private network (“VPN”) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100.

External systems 270 and 272 represent any number and variety of data sources, users, consumers, customers, enterprises, and groups of any size. In at least one example, the external systems 270 and 272 represent remote terminal utilized by the enterprise system 200 in serving users 110. In another example, the external systems 270 and 272 represent electronic systems for processing payment transactions. The system may also utilize software applications that function using external resources 270 and 272 available through a third-party provider, such as a Software as a Service (“SaaS”), Platform as a Service (“PaaS”), or Infrastructure as a Service (“IaaS”) provider running on a third-party cloud service computing device. For instance, a cloud computing device may function as a resource provider by providing remote data storage capabilities or running software applications utilized by remote devices.

SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

The embodiment shown in FIG. 1 is not intended to be limiting, and one of ordinary skill in the art will appreciate that the system and methods of the present invention may be implemented using other suitable hardware or software configurations. For example, the system may utilize only a single computing system 206 implemented by one or more physical or virtual computing devices, or a single computing device may implement one or more of the computing system 206, agent computing device 206, or user computing device 104 & 106.

### Artificial Intelligence

A machine learning program may be configured to implement stored processing, such as decision tree learning, association rule learning, artificial neural networks, recurrent artificial neural networks, long short-term memory (“LSTM”) networks, inductive logic programming, support vector machines, clustering, Bayesian networks, reinforcement learning, representation learning, similarity and metric learning, sparse dictionary learning, genetic algorithms, k-nearest neighbor (“KNN”), and the like. Additionally or alternatively, the machine learning algorithm may include one or more regression algorithms configured to output a numerical value in response to a given input. Further, the machine learning may include one or more pattern recognition algorithms—e.g., a module, subroutine or the like capable of translating text or string characters and/or a speech recognition module or subroutine. The machine learning modules may include a machine learning acceleration logic (e.g., a fixed function matrix multiplication logic) that implements the stored processes or optimizes the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (e.g., DBSCAN), mean shift clustering, expectation maximization (e.g., EM) clustering using Gaussian mixture models (e.g., GMM), agglomerative hierarchical clustering, or the like. In one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

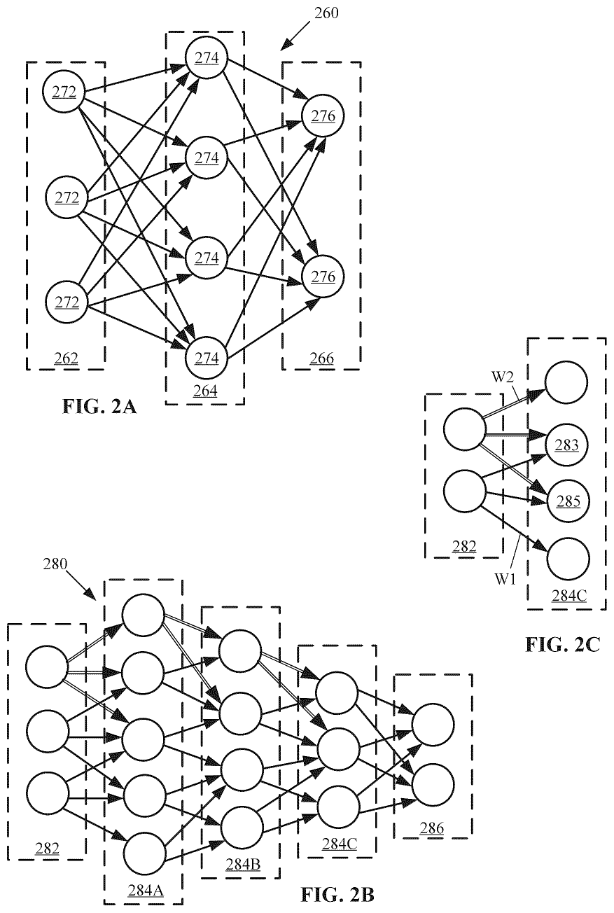

A feedforward network 260 (as depicted in FIG. 2A) may include a topography with a hidden layer 264 between an input layer 262 and an output layer 266. The input layer 262 includes input nodes 272 that communicate input data, variables, matrices, or the like to the hidden layer 264 that is implemented with hidden layer nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge.

In at least one embodiment of such a feedforward network, data are communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers. That is, the hidden layer 264 implements activation functions between the input data communicated from the input layer 262 and the output data communicated to the nodes 276 of the output layer 266.

It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem.

Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between −1 and 1) may be used to modify the previous coefficient (e.g., a propagated value). The machine learning algorithm may be considered sufficiently trained when the associated error amount for the output data are less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

An additional or alternative type of neural network suitable for use in the machine learning program and/or module is a Convolutional Neural Network (“CNN”). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program.

A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An example convolutional neural network CNN is depicted and referenced as 280 in FIG. 2B. As in the basic feedforward network 260 of FIG. 2A, the illustrated example of FIG. 2B has an input layer 282 and an output layer 286. However, where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

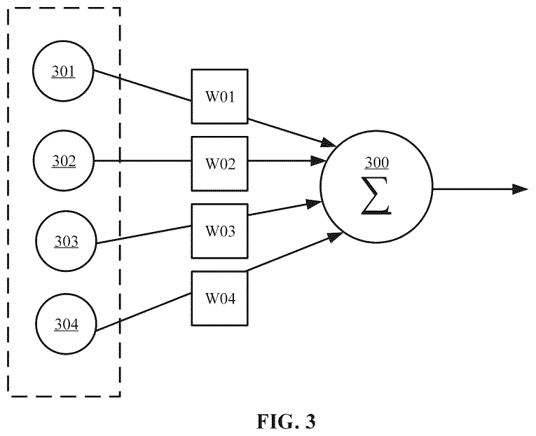

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional or alternative type of feedforward neural network suitable for use in the machine learning program and/or module is a Recurrent Neural Network (“RNN”). A RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter. That is, at least a portion of the output data from the RNN may be used as feedback or input in calculating subsequent output data. In some embodiments, the machine learning module may include an RNN configured for language processing (e.g., an RNN configured to perform statistical language modeling to predict the next word in a string based on the previous words). The RNN(s) of the machine learning program may include a feedback system suitable to provide the connection(s) between subsequent and previous layers of the network.

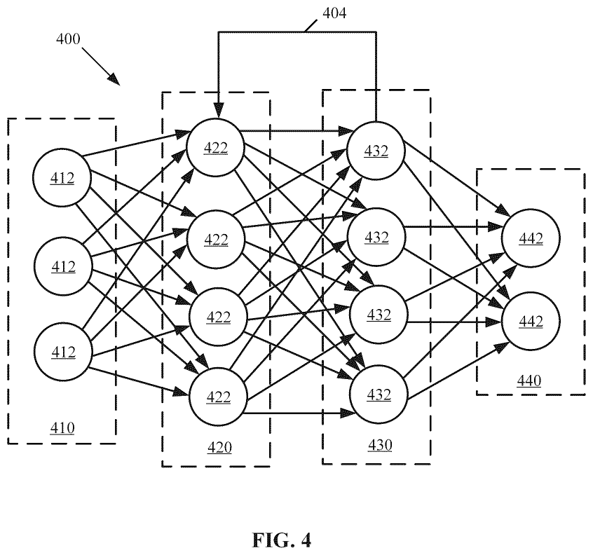

An example RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more nodes of a subsequent layer may provide or communicate a parameter or other data to a previous layer of the RNN network 400. Moreover, in some embodiments, the RNN 400 may include multiple feedback connectors 404 (e.g., connectors 404 suitable to communicatively couple pairs of nodes and/or connector systems 404 configured to provide communication between three or more nodes). Additionally or alternatively, the feedback connector 404 may communicatively couple two or more nodes having at least one hidden layer between them (i.e., nodes of nonsequential layers of the RNN 400).

In an additional or alternative embodiment, the machine learning program may include one or more support vector machines. A support vector machine may be configured to determine a category to which input data belongs. For example, the machine learning program may be configured to define a margin using a combination of two or more of the input variables and/or data points as support vectors to maximize the determined margin. Such a margin may generally correspond to a distance between the closest vectors that are classified differently. The machine learning program may be configured to utilize a plurality of support vector machines to perform a single classification. For example, the machine learning program may determine the category to which input data belongs using a first support vector determined from first and second data points/variables, and the machine learning program may independently categorize the input data using a second support vector determined from third and fourth data points/variables. The support vector machine(s) may be trained similarly to the training of neural networks (e.g., by providing a known input vector, including values for the input variables) and a known output classification. The support vector machine is trained by selecting the support vectors and/or a portion of the input vectors that maximize the determined margin.

As depicted, and in some embodiments, the machine learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers).

Generally, the neural network(s) of the machine learning program may include a relatively large number of layers (e.g., three or more layers) and are referred to as deep neural networks. For example, the node of each hidden layer of a neural network may be associated with an activation function utilized by the machine learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

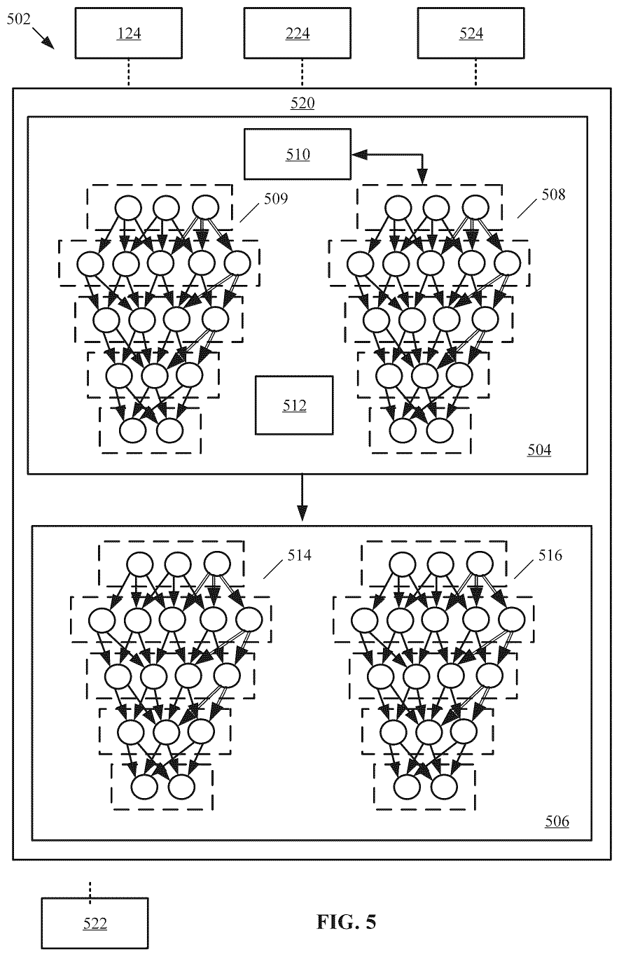

Referring now to FIG. 5 and some embodiments, an artificial intelligence program 502 may include a front-end algorithm 504 and a back-end algorithm 506. The artificial intelligence program 502 may be implemented on an AI processor 520. The instructions associated with the front-end algorithm 504 and the back-end algorithm 506 may be stored in an associated memory device and/or storage device of the system (e.g., storage device 124, memory device 122, storage device 124, and/or memory device 222) communicatively coupled to the AI processor 520, as shown. Additionally or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end network 504 configured to perform pre-processing, such as feature recognition, and a back-end network 506 configured to perform an operation on the data set communicated directly or indirectly to the back-end network 506). For instance, the front-end program 506 can include at least one CNN 508 communicatively coupled to send output data to the back-end network 506.

Additionally or alternatively, the front-end program 504 can include one or more AI algorithms 510, 512 (e.g., statistical models or machine learning programs such as decision tree learning, associate rule learning, recurrent artificial neural networks, support vector machines, and the like). In various embodiments, the front-end program 504 may be configured to include built in training and inference logic or suitable software to train the neural network prior to use (e.g., machine learning logic including, but not limited to, image recognition, mapping and localization, autonomous navigation, speech synthesis, document imaging, or language translation, such as natural language processing). For example, a CNN 508 and/or AI algorithm 510 may be used for image recognition, input categorization, and/or support vector training.

In some embodiments and within the front-end program 504, an output from an AI algorithm 510 may be communicated to a CNN 508 or 509, which processes the data before communicating an output from the CNN 508, 509 and/or the front-end program 504 to the back-end program 506. In various embodiments, the back-end network 506 may be configured to implement input and/or model classification, speech recognition, translation, and the like. For instance, the back-end network 506 may include one or more CNNs (e.g., CNN 514) or dense networks (e.g., dense networks 516), as described herein.

For instance and in some embodiments of the AI program 502, the program may be configured to perform unsupervised learning, in which the machine learning program performs the training process using unlabeled data (e.g., without known output data with which to compare). During such unsupervised learning, the neural network may be configured to generate groupings of the input data and/or determine how individual input data points are related to the complete input data set (e.g., via the front-end program 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data are known (e.g., a mix of labeled and unlabeled data having the same distribution).

In some embodiments, the AI program 502 may be accelerated via a machine learning framework 520 (e.g., hardware). The machine learning framework may include an index of basic operations, subroutines, and the like (primitives) typically implemented by AI and/or machine learning algorithms. Thus, the AI program 502 may be configured to utilize the primitives of the framework 520 to perform some or all of the calculations required by the AI program 502. Primitives suitable for inclusion in the machine learning framework 520 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine learning program may include variations, adaptations, and alternatives suitable to perform the operations necessary for the system, and the present disclosure is equally applicable to such suitably configured machine learning and/or artificial intelligence programs, modules, etc. For instance, the machine learning program may include one or more long short-term memory (“LSTM”) RNNs, convolutional deep belief networks, deep belief networks DBNs, and the like. DBNs, for instance, may be utilized to pre-train the weighted characteristics and/or parameters using an unsupervised learning process. Further, the machine learning module may include one or more other machine learning tools (e.g., Logistic Regression (“LR”), Naive-Bayes, Random Forest (“RF”), matrix factorization, and support vector machines) in addition to, or as an alternative to, one or more neural networks, as described herein.

Those of skill in the art will also appreciate that other types of neural networks may be used to implement the systems and methods disclosed herein, including, without limitation, radial basis networks, deep feed forward networks, gated recurrent unit networks, auto encoder networks, variational auto encoder networks, Markov chain networks, Hopefield Networks, Boltzman machine networks, deep belief networks, deep convolutional networks, deconvolutional networks, deep convolutional inverse graphics networks, generative adversarial networks, liquid state machines, extreme learning machines, echo state networks, deep residual networks, Kohonen networks, and neural turning machine networks, as well as other types of neural networks known to those of skill in the art.

To implement natural language processing technology, suitable neural network architectures can include, without limitation: (i) multilayer perceptron (“MLP”) networks having three or more layers and that utilizes a nonlinear activation function (mainly hyperbolic tangent or logistic function) that allows the network to classify data that is not linearly separable; (ii) convolutional neural networks; (iii) recursive neural networks; (iv) recurrent neural networks; (v) Long Short-Term Memory (“LSTM”) network architecture; (vi) Bidirectional Long Short-Term Memory network architecture, which is an improvement upon LSTM by analyzing word, or communication element, sequences in forward and backward directions; (vii) Sequence-to-Sequence networks; and (viii) shallow neural networks such as word2vec (i.e., a group of shallow two-layer models used for producing word embedding that takes a large corpus of alphanumeric content data as input to produces a vector space where every word or communication element in the content data corpus obtains the corresponding vector in the space).

With respect to clustering software processing techniques that implement unsupervised learning, suitable neural network architectures can include, but are not limited to: (i) Hopefield Networks; (ii) a Boltzmann Machines; (iii) a Sigmoid Belief Net; (iv) Deep Belief Networks; (v) a Helmholtz Machine; (vi) a Kohonen Network where each neuron of an output layer holds a vector with a dimensionality equal to the number of neurons in the input layer, and in turn, the number of neurons in the input layer is equal to the dimensionality of data points given to the network; (vii) a Self-Organizing Map (“SOM”) having a set of neurons connected to form a topological grid (usually rectangular) that, when presented with a pattern, the neuron with closest weight vector is considered to be the output with the neuron's weight adapted to the pattern, as well as the weights of neighboring neurons, to naturally find data clusters; and (viii) a Centroid Neural Network that is premised on K-means clustering software processing techniques.

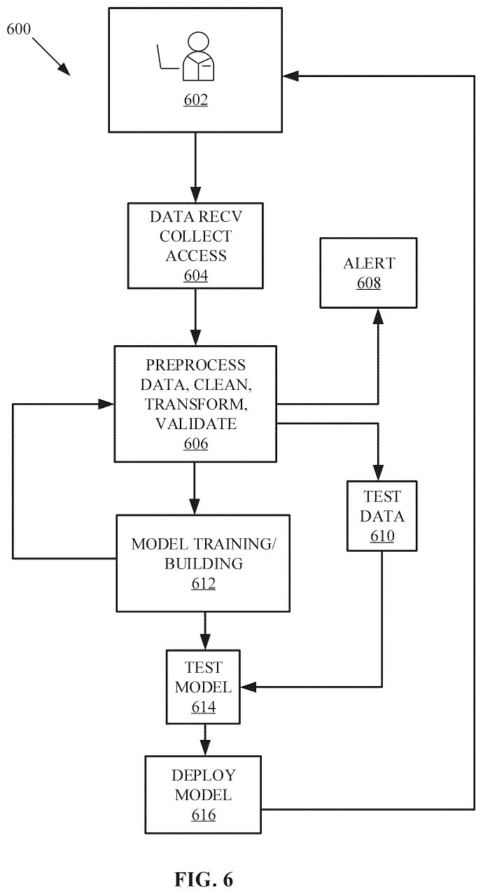

Turning to FIG. 6, a flow chart representing a method 600, according to at least one embodiment, of model development and deployment by machine learning. The method 600 represents at least one example of a machine learning workflow in which steps are implemented in a machine learning project.

In step 602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop.

In step 604, end user data are received, collected, accessed, or otherwise acquired and entered as can be termed data ingestion. In step 606 the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data are subsequently collected and entered, a new model will be generated. If the preprocessing step 606 is updated with newly ingested data, an updated model will be generated.

Step 606 can include data validation to confirm that the statistics of the ingested data are as expected, such as that data values are within expected numerical ranges, that data sets are within any expected or required categories, and that data comply with any needed distributions such as within those categories. Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning workflow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

### Natural Language Processing

Human-readable alphanumeric content data, or text data, representing linguistic expressions can be processed using natural language processing technology that is implemented by one or more artificial intelligence software applications and systems. The artificial intelligence software and systems are in turn implemented using neural networks. Natural language processing technology analyzes one or more files that include alphanumeric text data composed of individual communication elements, such as words, symbols or numbers. Natural language processing software techniques can be implemented with supervised or unsupervised learning techniques. Unsupervised learning techniques identify and characterize hidden structures of unlabeled text data. Supervised techniques operate on labeled text data and include instructions informing the system which outputs are related to specific input values.

Supervised software processing rely on iterative training techniques and training data to configure neural networks with an understanding of individual words, phrases, subjects, sentiments, and parts of speech. As an example, training data are utilized to train a neural network to recognize that phrases like “listing a home,” “put it on the market,” or “selling my house” all relate to the same general subject matter when the words are observed in proximity to one another at a significant frequency of occurrence.

Supervised learning software systems are trained using text data that is well-labeled or “tagged.” During training, the supervised software systems learn the best mapping function between a known data input and expected known output (i.e., labeled or tagged text data). Supervised natural language processing software then uses the best approximation mapping learned during training to analyze previously unseen input data to accurately predict the corresponding output. Supervised learning software systems require iterative optimization cycles to adjust the input-output mapping until the networks converge to an expected and well-accepted level of performance, such as an acceptable threshold error rate between a calculated probability and a desired threshold probability. The software systems are supervised because the way of learning from training data mimics the same process of a teacher supervising the end-to-end learning process. Supervised learning software systems are typically capable of achieving excellent levels of performance when enough labeled data are available.

Supervised learning software systems utilize neural network technology that includes, without limitation, Latent Semantic Analysis (“LSA”), Probabilistic Latent Semantic Analysis (“PLSA”), Latent Dirichlet Allocation (“LDA”), or Bidirectional Encoder Representations from Transformers (“BERT”). Latent Semantic Analysis software processing techniques process a corpus of text data files to ascertain statistical co-occurrences of words that appear together which then yields insights into the subjects of those words and documents.

Unsupervised learning software systems can perform training operations on unlabeled data and require less time and expertise from trained data scientists. Unsupervised learning software systems can be designed with integrated intelligence and automation to automatically discover information, structure, and patterns from text data. Unsupervised learning software systems can be implemented with clustering software techniques that include, without limitation, K-mean clustering, Mean-Shift clustering, Density-based clustering, Spectral clustering, Principal Component Analysis, and Neural Topic Modeling (“NTM”). Clustering software techniques can automatically group semantically similar user utterances together to accelerate the derivation and verification of an underlying common user intent—i.e., ascertaining or deriving a new classification or subject, rather than classifying data into an existing subject or classification.

The software utilized to implement the present systems and methods can utilize one or more supervised or unsupervised software processing techniques to perform a subject classification analysis to generate subject data that characterizes the topics addressed by a corpus of one or more files that include text data. Suitable software processing techniques can include, without limitation, Latent Semantic Analysis, Probabilistic Latent Semantic Analysis, Latent Dirichlet Allocation. Latent Semantic Analysis software processing techniques generally process a corpus of text files, or documents, to ascertain statistical co-occurrences of words that appear together which then gives insights into the subjects of those words and documents. The system software services can utilize software processing techniques that include Non-Matrix Factorization, Correlated Topic Model (“CTM”), and K-Means or other types of clustering.

The linguistic or alphanumeric text data input to the system can be first pre-processed to remove unqualified text data that does not meaningfully contribute to the subject classification analysis. The qualification operation removes certain text data according to criteria defined by a provider. For instance, the qualification analysis can determine whether text data files are “empty” and contain no recorded linguistic interaction and designate such empty files as not suitable for use in a subject classification analysis. As another example, the qualification analysis can designate files below a certain size or having a spoken duration below a given threshold (e.g., less than two seconds) as also being unsuitable for use in a subject classification analysis.

The pre-processing can also include contradiction operation to remove contradictions and punctuations from the text data. Contradictions and punctuation include removing or replacing abbreviated words or phrases that cause inaccuracies in a subject classification analysis. Examples include removing or replacing the abbreviations “min” for minute, “u” for you, and “wanna” for “want to,” as well as apparent misspellings, such as “mssed” for the word missed. The contradictions can optionally be replaced according to a standard library of known abbreviations, such as replacing the acronym “brb” with the phrase “be right back.” The contradiction operation can also remove or replace contractions, such as replacing “we're” with “we are.”

The system can also streamline the text data by performing one or more of the following operations, including: (i) tokenization to transform the text data into a collection of words or key phrases having punctuation and capitalization removed; (ii) stop word removal where short, common words or phrases such as “the” or “is” are removed; (iii) lemmatization where words are transformed into a base form, like changing third person words to first person and changing past tense words to present tense; (iv) stemming to reduce words to a root form, such as changing plural to singular; and (v) hyponymy and hypernym replacement where certain words are replaced with words having a similar meaning so as to reduce the variation of words within the text data.

Following one or more of the above pre-processing operations, the text data are vectorized to map the alphanumeric text into a vector form. One approach to vectorising text data includes applying “bag-of-words” modeling. The bag-of-words approach counts the number of times a particular word appears in text data to convert the words into a numerical value. The bag-of-words model can include parameters, such as setting a threshold on the number of times a word must appear to be included in the vectors.

Techniques to encode the context of words, or communication elements, determine how often communication elements appear together. Determining the adjacent pairing of communication elements can be achieved by creating a co-occurrence matrix with the value of each member of the matrix counting how often one communication element coincides with another, either just before or just after it. That is, the words or communication elements form the row and column labels of a matrix, and a numeric value appears in matrix elements that correspond to a row and column label for communication elements that appear adjacent in the text data.

As an alternative to counting communication elements (i.e., words) in a corpus of text data and turning it into a co-occurrence matrix, another software processing technique is to use a communication element in the text data corpus to predict the next communication element. Looking through a corpus, counts are generated for adjacent communication elements, and the counts are converted from frequencies into probabilities (i.e., using n-gram predictions with Kneser-Ney smoothing) using a simple neural network. Suitable neural network architectures for such purpose include a skip-gram architecture. The neural network is trained by feeding through a large corpus of text data, and embedded middle layers in the neural network are adjusted to best predict the next word.

The predictive processing creates weight matrices that densely carry contextual, and hence semantic, information from the selected corpus of text data. Pre-trained, contextualized text data embedding can have high dimensionality. To reduce the dimensionality, a Uniform Manifold Approximation and Projection algorithm (“UMAP”) can be applied to reduce dimensionality while maintaining essential information.

Prior to conducting a subject analysis to ascertain subjects identifiers in the text data (i.e., topics or subjects addressed in the text data), the system can perform a concentration analysis on the text data. The concentration analysis concentrates, or increases the density of, the text data by identifying and retaining communication elements having significant weight in the subject analysis and discarding communication elements having relativity little weight.

In one embodiment, the concentration analysis includes executing a frequency-inverse document frequency (“tf-idf”) software processing technique to determine the frequency or corresponding weight quantifier for communication elements with the text data. The weight quantifiers are compared against a pre-determined threshold to generate concentrated text data that is made up of communication elements having weight quantifiers above the weight threshold.

The concentrated text data are processed using a subject classification analysis to determine subject identifiers (i.e., topics) addressed within the text data. In one embodiment, the subject classification analysis is performed on the text data using a Latent Dirichlet Allocation analysis to identify subject data that includes one or more subject identifiers (e.g., topics addressed in the underlying text data). Performing the LDA analysis on the reduced text data may include transforming the text data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (i.e., the words with the five highest probabilities), or the subject is represented by text data having probabilities above a predetermined subject probability threshold.

Clustering software processing techniques include K-means clustering, which is an unsupervised processing technique that does not utilized labeled text data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recalculated, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (i.e., keywords, phrases, symbols, etc.) within the text data as well as a frequency of the one or more communication elements within the text data.

Alternatively, instead of selecting a pre-determined number of communication elements, post-clustering concentration analysis can analyze the subject vectors to identify communication elements that are included in a number of subject vectors having a weight quantifier (e.g., a frequency) below a specified weight threshold level that are then removed from the subject vectors. In this manner, the subject vectors are refined to exclude text data less likely to be related to a given subject. To reduce an effect of spam, the subject vectors may be analyzed, such that if one subject vector is determined to include communication elements that are rarely used in other subject vectors, then the communication elements are marked as having a poor subject correlation and is removed from the subject vector.

In another embodiment, the concentration analysis is performed on unclassified text data by mapping the communication elements within the text data to integer values. The text data are thus, turned into a bag-of-words that includes integer values and the number of times the integers occur in text data. The bag-of-words is turned into a unit vector, where all the occurrences are normalized to the overall length. The unit vector may be compared to other subject vectors produced from an analysis of text data by taking the dot product of the two unit vectors. All the dot products for all vectors in a given subject are added together to provide a weighting quantifier or score for the given subject identifier, which is taken as subject weighting data. A similar analysis can be performed on vectors created through other processing, such as Kmeans clustering or techniques that generate vectors where each word in the vector is replaced with a probability that the word represents a subject identifier or request driver data.

To illustrate generating subject weighting data, for any given subject there may be numerous subject vectors. Assume that for most of subject vectors, the dot product will be close to zero—even if the given text data addresses the subject at issue. Since there are some subjects with numerous subject vectors, there may be numerous small dot products that are added together to provide a significant score. Put another way, the particular subject is addressed consistently throughout a document or several documents, and the recurrence of the carries significant weight.

In another embodiment, a predetermined threshold may be applied where any dot product that has a value less than the threshold is ignored and only stronger dot products above the threshold are summed for the score. In another embodiment, this threshold may be empirically verified against a training data set to provide a more accurate subject analyses.

In another example, a number of subject identifiers may be substantially different, with some subjects having orders of magnitude fewer subject vectors than others. The weight scoring might significantly favor relatively unimportant subjects that occur frequently in the text data. To address this problem, a linear scaling on the dot product scoring based on the number of subject vectors may be applied. The result provides a correction to the score so that important but less common subjects are weighed more heavily.

Once all scores are calculated for all subjects, then subjects may be sorted, and the most probable subjects are returned. The resulting output provides an array of subjects and strengths. In another embodiment, hashes may be used to store the subject vectors to provide a simple lookup of text data (e.g., words and phrases) and strengths. The one or more subject vectors can be represented by hashes of words and strengths, or alternatively an ordered byte stream (e.g., an ordered byte stream of 4-byte integers, etc.) with another array of strengths (e.g., 4-byte floating-point strengths, etc.).

The system can also use term frequency-inverse document frequency software processing techniques to vectorize the text data and generating weighting data that weight words or particular subjects. The tf-idf is represented by a statistical value that increases proportionally to the number of times a word appears in the text data. This frequency is offset by the number of separate text data instances that contain the word, which adjusts for the fact that some words appear more frequently in general across multiple text data files. The result is a weight in favor of words or terms more likely to be important within the text data, which in turn can be used to weigh some subjects more heavily in importance than others. To illustrate with a simplified example, the tf-idf might indicate that the term “pool” carries significant weight within text data. To the extent any of the subjects identified by a natural language processing analysis include the term “pool,” that subject can be assigned more weight.

The text data can be visualized and subject to a reduction into two dimensional data using a Uniform Manifold Approximation and Projection algorithm (“UMAP”) to generate a cluster graph visualizing a plurality of clusters. The system feeds the two dimensional data into a Density Based Spatial Clustering of Applications with Noise algorithm (“DBSCAN”) and identify a center of each cluster of the plurality of clusters. The process may, using the two dimensional data from the UMAP and the center of each cluster from the DBSCAN, apply a K-Nearest neighbor algorithm (“KNN”) to identify data points closest to the center of each cluster and shade each of the data points to graphically identify each cluster of the plurality of clusters. The processor may illustrate a graph on the display representative of the data points shaded following application of the KNN.

The system further analyzes the text data through, for example, semantic segmentation to identify attributes of the text data. Attributes include, for instance, parts of speech, such as the presence of particular interrogative words, such as who, whom, where, which, how, or what. In another example, the text data are analyzed to identify the location in a sentence of interrogative words and the surrounding context. For instance, sentences that start with the words “what” or “where” are more likely to be questions than sentence having these words placed in the middle of the sentence (e.g., “I don't know what to do,” as opposed to “What should I do?” or “Where is the word?” as opposed to “Locate where in the sentence the word appears.”). In that case, the closer the interrogative word is to the beginning of a sentence, the more weight that is given to the probability it is a question word when applying neural networking techniques.

The system can also incorporate Part of Speech (“POS”) tagging software code that assigns words a parts of speech depending upon the neighboring words, such as tagging words as a noun, pronoun, verb, adverb, adjective, conjunction, preposition, or other relevant parts of speech. The system can utilize the POS tagged words to help identify questions and subjects according to pre-defined rules, such as recognizing that the word “what” followed by a verb is also more likely to be a question than the word “what” followed by a preposition or pronoun (e.g., “What is this?” versus “What he wants is an answer.”).

POS tagging in conjunction with Named Entity Recognition (“NER”) software processing techniques can be used by the content driver software service to identify various content sources within the text data. NER techniques are utilized to classify a given word into a category, such as a person, product, organization, or location. Using POS and NER techniques to process the text data allow the content driver software service to identify particular words and text as a noun and as representing a person participating in the discussion (i.e., a content source).

The system can also perform a sentiment analysis to determine sentiment from the text data. Sentiment can indicate a view or attitude toward a situation or an event. Further, identifying sentiment in data can be used to determine a feeling, emotion or an opinion. The sentiment analysis can apply rule-based software applications or neural networking software applications, such as convolutional neural networks (discussed below), a lexical co-occurrence network, and bigram word vectors to perform sentiment analysis to improve accuracy of the sentiment analysis.

Polarity-type sentiment analysis (i.e., a polarity analysis) can apply a rule-based software approach that relies on lexicons, or lists of positive and negative words and phrases that are assigned a polarity score. For instance, words such as “fast,” “great,” or “easy” are assigned a polarity score of certain value while other words and phrases such as “failed,” “lost,” or “rude” are assigned a negative polarity score. The polarity scores for each word within the tokenized, reduced hosted text data are aggregated to determine an overall polarity score and a polarity identifier. The polarity identifier can correlate to a polarity score or polarity score range according to settings predetermined by an enterprise. For instance, a polarity score of +5 to +9 may correlate to a polarity identifier of “positive,” and a polarity score of +10 or higher correlates to a polarity identifier of “very positive.”

To illustrate a polarity analysis with a simplified example, the words “great” and “fast” might be assigned a positive score of five (+5) while the word “failed” is assigned a score of negative ten (−10) and the word “lost” is assigned a score of negative five (−5). The sentence “The agent failed to act fast” could then be scored as a negative five (−5) reflecting an overall negative polarity score that correlatives to a “somewhat negative” polarity indicator.

The system can also apply machine learning software to determine sentiment, including use of such techniques to determine both polarity and emotional sentiment. Machine learning techniques also start with a reduction analysis. Words are then transformed into numeric values using vectorization that is accomplished through a bag-of-words model, Word2Vec techniques, or other techniques known to those of skill in the art. Word2Vec, for example, can receive a text input (e.g., a text corpus from a large data source) and generate a data structure (e.g., a vector representation) of each input word as a set of words.

Each word in the set of words is associated with a plurality of attributes. The attributes can also be called features, vectors, components, and feature vectors. For example, the data structure may include features associated with each word in the set of words. Features can include, for example, size (e.g., big or little, long or short), action (e.g., a verb or noun), etc. that describe the words. Each of the features may be determined based on techniques for machine learning (e.g., supervised machine learning) trained based on association with sentiment.

Training the neural networks is particularly important for sentiment analysis to ensure parts of speech such as subjectivity, industry specific terms, context, idiomatic language, or negation are appropriately processed. For instance, the phrase “the seller's rates are lower than comparable listings” could be a favorable or unfavorable comparison depending on the particular context, which should be refined through neural network training.

Machine learning techniques for sentiment analysis can utilize classification neural networking techniques where a corpus of text data is, for example, classified according to polarity (e.g., positive, neural, or negative) or classified according to emotion (e.g., satisfied, contentious, etc.). Suitable neural networks can include, without limitation, Naive Bayes, Support Vector Machines using Logistic Regression, convolutional neural networks, a lexical co-occurrence network, bigram word vectors, Long Short-Term Memory.

Neural networks are trained using training set text data that comprise sample tokens, phrases, sentences, paragraphs, or documents for which desired subjects, content sources, interrogatories, or sentiment values are known. A labeling analysis is performed on the training set text data to annotate the data with known subject labels, interrogatory labels, content source labels, or sentiment labels, thereby generating annotated training set text data. For example, a person can utilize a labeling software application to review training set text data to identify and tag or “annotate” various parts of speech, subjects, interrogatories, content sources, and sentiments.

The training set text data are then fed to a natural language software service neural networks to identify subjects, content sources, or sentiments and the corresponding probabilities. For example, the analysis might identify that particular text represents a question with a 35% probability. If the annotations indicate the text is, in fact, a question, an error rate can be taken to be 65% or the difference between the calculated probability and the known certainty. Then parameters to the neural network are adjusted (i.e., constants and formulas that implement the nodes and connections between node), to increase the probability from 35% to ensure the neural network produces more accurate results, thereby reducing the error rate. The process is run iteratively on different sets of training set text data to continue to increase the accuracy of the neural network.

For some embodiments, the system is configured to determine relationships between and among subject identifiers and sentiment identifiers. Determining relationships among identifiers can be accomplished through techniques, such as determining how often two identifier terms appear within a certain number of words of each other in a set of text data packets. The higher the frequency of such appearances, the more closely the identifiers would be said to be related.

A useful metric for degree of relatedness that relies on the vectors in the data set as opposed to the words is cosine similarity. Cosine similarity is a technique for measuring the degree of separation between any two vectors, by measuring the cosine of the vectors' angle of separation. If the vectors are pointing in exactly the same direction, the angle between them is zero, and the cosine of that angle will be one (1), whereas if they are pointing in opposite directions, the angle between them is “pi” radians, and the cosine of that angle will be negative one (−1). If the angle is greater than pi radians, the cosine is the same as it is for the opposite angle; thus, the cosine of the angle between the vectors varies inversely with the minimum angle between the vectors, and the larger the cosine is, the closer the vectors are to pointing in the same direction.

### Capturing End User Data

The systems and methods disclosed herein capture a wide variety of end user data relating to user demographic information, user interests, user activities, user preferences, and user activity, among other types of data. The end user data can be input by users in response to various system prompts displayed on a GUI or automatically captured by user computing devices in response to user activities, such as browsing the Internet (i.e., “navigation data” described below), taking photographs, or changes in user geographic location (i.e., capturing user changes in position through a GPS system integrated with the user computing device). End user data can include, without limitation: (i) end user account data; (ii) navigation data; (iii) system configuration data; and (iv) user activity data.

End user data are captured when a user first accesses the provider system by logging in through a website or launching a dedicated provider mobile software application installed on the user computing device. When utilizing an Internet browser software application, for example, the user computing device transmits an user interface transmit command to an Internet Protocol (“IP”) address for the provider system, such as a provider web server. The user interface transmit command requests display data to be displayed on the user computing device (e.g., a webpage). Alternatively, user computing devices access the provider system through a provider mobile software application that displays GUI screens.

In accessing the provider system, the user computing device transmits a user interface transmit command to the provider system that can include: (i) an Internet Protocol (“IP”) address for the user computing device; (ii) navigation data; and (iii) system configuration data. In response to the user interface transmit command, the web server returns provider display data and a digital cookie that is stored to the user computing device and used to track functions and activities performed by the user computing device.

In some embodiments, the navigation data and system configuration data are utilized by the provider system to generate the provider display data. For instance, the system configuration data may indicate that the user computing device is utilizing a particular Internet browser or mobile software application to communicate with the provider system. The provider system then generates provider display data that includes instructions compatible with, and readable by, the particular Internet browser or mobile software application. As another example, if the navigation data indicates the user computing device previously visited a provider webpage, the provider display data can include instructions for displaying a customized message on the user computing device, such as “Welcome back Dawn!”.

After receiving provider display data, the user computing device processes the display data and renders GUI screens presented to users, such as a provider website or a GUI within a provider mobile software application. The provider system also transmits the navigation data and system configuration data to a provider back end system for further processing. Note that in some embodiments, the navigation data and system configuration data may be sent to the provider system in a separate message subsequent to the user interface transmit command message.

The provider display data can include one or more of the following: (i) webpage data used by the user computing device to render a webpage in an Internet browser software application; and (ii) mobile app display data used by the user computing device to render GUI screens within a mobile software application. Categories of webpage or mobile app display data can include graphical elements, digital images, text, numbers, colors, fonts, or layout data representing the orientation and arrangement graphical elements and alphanumeric data on a user interface screen.

Navigation data transmitted by the user computing device generally includes information relating to prior functions and activities performed by the user computing device. Examples of navigation data include: (i) navigation history data (i.e., identifiers like website names and IP addresses showing websites previously access by the user computing device); (ii) redirect data (i.e., data indicating whether the user computing device selected a third-party universal resource locator (“URL”) link that redirected to the provider web server); and (iii) search history data (e.g., data showing keyword searches in a search engine, like Google® or Bing®, performed by the user computing device).

Navigation history data allows a provider to determine whether a user computing device was previously used to visit particular websites, such as websites representing points of interest in a particular geographic area or websites relating to professional, educational, or recreational activities and opportunities. Examples could include websites for restaurants in a community, schools, retailers, zoos, or professional sporting venues, among numerous other types of activities and opportunities. The navigation history data includes, without limitation: (i) URL data identifying a hyperlink link to the website; (ii) website identification data, such as a title of a visited website; (iii) website IP address data indicating an IP address for a web server associated with a visited website; (iv) time stamp data indicating the date and time when a website was accessed; (v) meta tags; and/or (vi) content data, such as alphanumeric text displayed on a website visited by a consumer.

The system utilizes navigation data to determine additional relevant data. For instance, the system captures navigation data relating to a website visited by an end user that corresponds to a point of interest in a given community or geographic area, such as the website title, keywords or phrases from the website content, or a website IP address. The navigation data are passed to an application programming interface (“API”) that interfaces with a database hosted by the provider system or by a third-party (e.g., a SaaS provider) to return geographic location data for the corresponding point of interest. In one embodiment, the system utilizes artificial intelligence technology to perform a subject analysis to determine a category corresponding to the website visited by the user and the associated point of interest. The system then determines additional points of interest similar to the website visited by the end user.

To illustrate the foregoing function with references to simplified examples, the user computing device may navigate to a website corresponding to an elementary school and a website corresponding to a performing arts center. The provider system receives navigation data that includes the website IP address, website title, and website content. The provider system can pass the website IP address and title to an Location API that accesses a separate software process or system to determine a geographic area or address for the school and the performing arts center. The provider system also passes the website title and content data to an API that interfaces with a separate software process or system that uses natural language processing technology to detect words like “curriculum,” student,” or “grade,” or “performance,” “orchestra,” or “show,” to determine the visited websites relate to an elementary school and a performing arts center.

Continuing with the foregoing example, when a user computing device conducts a search for properties, the provider system can display a map or other GUI that shows data such as: (i) the location of the particular school and performing arts center associated with the visited websites; (ii) the distance between a given property and the school or performing arts center associated with the visited websites; and (iii) the locations of other elementary schools and arts centers, museums, or cultural centers in the area.

In addition to navigation data, the system can also analyze user preference data and end user account data (discussed below) using artificial intelligence technology to further refine points of interest to the end user. The provider system can receive user account data indicating that the end user is 30 years of age, married, and has an income level above a certain threshold. The system utilizes this data in conjunction with the navigation data to further refine the particular schools or arts centers displayed to the end user following a search.

More specifically, the system uses artificial intelligence techniques to perform an analysis that determines probabilities that an end user would select a graphical icon or function on a display to visit a website associated with a school or other point of interest, which corresponds to a likelihood that the end user would demonstrate an interest in a place or location. Points of interest having the top five or ten (or another number) highest probabilities or having probabilities above a predetermined threshold are displayed on the user computing device. For instance, a predictive analysis may determine that an end user who previously visited a website for a private elementary school and that has a significantly high income will be more interested in private schools in a geographic area. Such schools can then be prioritized in search results displayed on the user computing device.

Turning again to the capture of navigation data, the system captures redirect data that indicates whether the user computing device selected a third party link that redirected the user computing device to a particular listing or third party website. For instance, a user might select a hyperlink displayed within an Internet browser in response to a search engine query or select a hyperlink displayed on a social media feed. Selecting the third party hyperlink causes the user computing device to transmit a user interface transmit command to a provider front end server (e.g., a webserver). The redirect data includes information that identifies the source of the third-party hyperlink, such as identifying a particular social platform or website where an advertisement or property listing was displayed.

The redirect data thus indicate what social media platforms or types of advertisements or postings are of particular interest to an end user. Such data provides useful inputs to a predictive analysis conducted using artificial intelligence technology. For example, a predictive analysis may determine that Facebook users are more likely to purchase higher value property than Instagram users; that Instagram users are more likely to purchase property situated in urban areas; or that a user who was redirected from an advertisement showing a multifamily property is more likely to purchase a condominium than a single family home. These probabilities are then used to refine search results displayed to particular users, such that higher value properties are prioritized for display to Facebook users or multifamily properties are prioritized for display to users who selected a particular advertisement or post, as determined from the redirect data.

Navigation further includes search history data that is generated when a user computing device runs a query within a search engine. The search history data can include, without limitation: (i) a search engine identifier indicating the search engine that was utilized; (ii) search parameter data indicating the alphanumeric strings or operators used as part of a search query (e.g., Boolean operators such as “AND” or “OR” or functional operators, like “insite” used to search the contents of a specific website); and (iii) time stamp or sequencing data indicating the date and time a search was performed. Similar to above, search history data can be processed using natural language processing and artificial intelligence technology to discern particular subjects of interest to an end user that is, in turn, utilized to determine particular properties that have a higher probability of being visited or purchased by an end user.

The user computing device may also transmit system configuration data to the provider system that is used to evaluate a user or authenticate the user computing device. System configuration data can include, without limitation: (i) a unique identifier for the user computing device (e.g., a media access control (“MAC”) address hardcoded into a communication subsystem of the user agent computing device); (ii) a MAC address for the local network of a user computing device (e.g., a router MAC address); (iii) copies of key system files that are unlikely to change between instances when a user accesses the provider system; (iv) a list of applications running or installed on the user computing device; and (v) any other data useful for evaluating users and authenticating a user or user computing device.

The user computing device optionally authenticates to the provider system if, for instance, the user has an existing electronic account with the provider. The user computing device navigates to a login interface and enters user authentication data, such as a user name and password. The user then selects a submit function on a user interface display screen to transmit a user authentication request message that includes the user authentication data to the provider web server. In some embodiments, the user authentication data and user authentication request message can further include elements of the system configuration data that are used to authenticate the user, such as a user computing device identifier or internet protocol address that are compared against known values stored to the provider system.

A provider front end server passes user authentication request message to an identity management service, which performs a verification analysis to verify the identity of the user or the user computing device. The verification analysis compares the received user authentication data to stored user authentication data to determine whether the authentication data sets match. The identity management service determines whether a correct user name, password, device identifier, or other authentication data are received. The identity management service returns an authentication notification message that can include a verification flag indicating whether the verification passed or failed and a reason for any failed authentication, such as an unrecognized user name, password, or user computing device identifier.

When creating an account with a provider, the system prompts the user through a series of GUIs to enter a variety of end user account data, such as the user's name and contact information. The end user data are stored to an End User Database as one or more database records. The End User Database is implemented as a relational database capable of associating various types of data and information stored to the system, such as associating property listings and property showings saved by a user with the user's name, contact information, and navigation data.

The end user account data can include, without limitation, a variety of information, such as: (i) a unique user identifier (i.e., a user name); (ii) user domicile data, including a mailing address or a geographic region where the user resides (e.g., a zip code, city, state); (iii) user contact data, such as user telephone number data and an email address; (iv) user demographic data, including the gender, age, marital status, occupation, yearly income, and educational background of a user as well as changes in end user demographic data, such as a recent change in marital status; (v) user occupational data, such as an identifier for the end user's employer, business, or occupation or changes in an end user employment status, job position, or employer; (vi) user household data, such the ages, genders, relationship, and number of individuals that cohabitate with a user (e.g., number, ages, and gender of any children) as well as changes in household data, such as an end user becoming an “empty nester” after children move from the home; (vii) user residential data describing the user's current residence by size, configuration, or type (e.g., number of bedrooms and bathrooms, multi-family, single family home, etc.); (viii) user interest data relating to subjects or activities of interest to a user, such as sports, shopping, or fitness; and (ix) end user role data charactering how an end user interacts with the provider system, such as data denoting an end user as a transfer source (e.g., a seller), a transfer destination (e.g., a buyer), or an intermediary (e.g., an agent).

End user data can also be captured from third party data sources and used to supplement the end user data input by the end user. For example, the system can search the Internet for information relevant to an end user, interface with an API that sends notifications to the provider system relating to an end user, or an end user can link a provider account with an end user social media account so that the provider system receives social media data relating to the end user. Internet searches, third party notifications, or social media data can be analyzed using natural language processing technology to identify subjects/topics and sentiment stored by the system and associated with the end user data. For example, the provider system can receive social media data or a news article that is analyzed using natural language processing to determine that the social media data or article relate to a professional job promotion, a change in job location, or a life event experienced by an end user (e.g., recently married, had a child, or obtained a graduate degree).

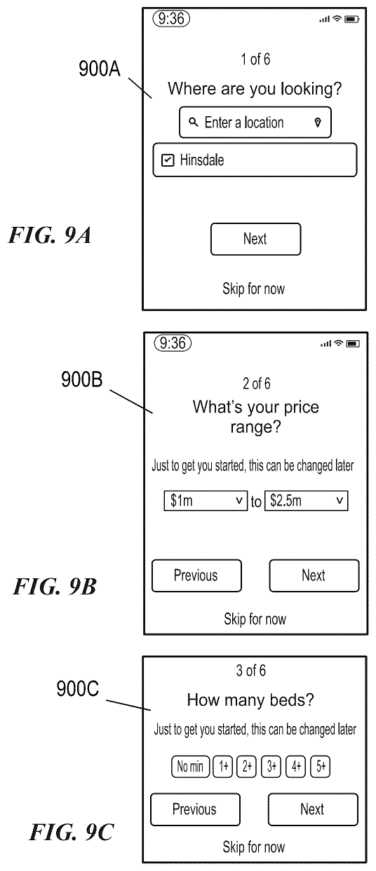

Users can also navigate various system GUIs to enter and edit preference data that characterizes products, services, or properties that are of interest to a user. As an example, the GUIs 900A, 900B, 900C depicted in FIGS. 9A-9C are displayed when a user registers an account with the provider or when a user selects a function to initiate a new property, product, or service search request. The example GUIs 900A, 900B, 900C shown in FIGS. 9A-9C prompt end users to input data that are utilized to identify potential residential real estate properties that an end user is likely to view or purchase. The GUIs 900A, 900B, 900C request information, such as a geographic location, a price range, the number of bedrooms, number of bathrooms, the size by minimum to maximum square footage, as well as a narrative description of potential property features sought by a user (e.g., pool, two-car garage, etc.).

The system also collects end user data based on system or user computing device utilization by the end user. The end user data can include activity data representing functions performed by the user computing device. Activity data sources include hardware components (e.g., a display screen, camera, or telephonic components integrated with the user computing device) or software applications (e.g., Internet browser or a background operating system process) that are utilized by the user while operating the user computing device. The activity data can be transmitted using JavaScript Object Notation (“JSON”) or any other suitable format. The activity data can be transmitted as packets to the provider system asynchronously as each event occurs to ensure real-time capture of relevant activity data.

The available activity data fields and content for activity event data packets are customizable and will generally vary depending on, among other things, the activity data source software application. Example activity data fields include, but are not limited to: (i) time and date data; (ii) an event identifier that can be used to determine the activity represented by the event data (e.g., answering the phone, typing or sending a message, performing an Internet or database search); (iii) an event type indicating the category of activities represented by the event (e.g., a phone event, a search event); (iv) an event source identifier that identifies the software application or hardware device originating corresponding activity data (i.e., an Internet browser, mobile software application, camera, or microphone); (v) an endpoint identifier such as a device identifier or unique user identifier; and (vi) any other information available from the event source that is useful for characterizing and analyzing a shared experience between a provider and a customer.

Activity data sources can include various proprietary and non-proprietary software applications running on the user computing devices. Non-proprietary or commercial software applications running on the user computing devices can include, for instance, the computing device operating system software (e.g., Microsoft Windows®), Java® virtual machine, or Internet browser applications (e.g., Google Chrome® or Microsoft Edge®). The proprietary and non-proprietary software applications capture event data such as text entered in a graphical user interface, the selection of an input function that initiates a property address search in a mobile application, or sending a communication through an email or social media software application.

Proprietary software applications can be designed and preconfigured to asynchronously capture activity data in real time for transmission directly to the provider system. For example, a provider mobile application can be configured to capture the number and location of photographs taken by a user computing device during a designated time period at a designated location, such as during a pre-scheduled property showing. Alternatively, where a protocol for reading the output of a non-proprietary software application cannot be established, the system may utilize techniques such as “screen scraping” that captures human-readable outputs from the non-proprietary application intended for display on a display device integrated with the user computing device.

The captured activity data can include, but is not limited to: (i) provider mobile application usage data indicating, among other things, particular listings viewed by a user and the amount of time spent viewing each particular listing as a gauge of user interest; (ii) user geolocation data captured from an integrated GPS system; (iii) third party mobile application usage data indicating, for example, the identity of dedicated mobile applications for particular retailers or service providers utilized by an end user; (iv) audio data captured from a user computing device microphone; or (v) content data, such as alphanumeric text messages, image content, and video content created and transmitted by an end user computing device.

The activity data are stored to the provider system and processed utilizing artificial intelligence and natural language processing activity to further enhance system operations. The provider system can capture, for instance, alphanumeric or audio messages generated and transmitted by a user during a property evaluation or showing, such as messages indicating that a user liked or disliked a room or feature of the property.

The content data of the alphanumeric or audio messages are processed using natural language processing technology to determine the subjects to which the content data relates as well as a polarity of the data, such as a positive expression of sentiment concerning a large kitchen. In some embodiments, an agent using a voice note functionality generates content data. For instance, an agent can activate the voice note functionality by selecting a “Copilot” icon and speaking, through a microphone input. The agent can save a voice recording related to a particular conversation, interaction, property, etc. For example, the agent may record “John Smith and his wife are looking for a four bedroom, two bath home in San Francisco. They do not want to spend more than two million.”

The speech or voice data is processed using speech-to-text techniques so that the voice note is stored as alphanumeric text content data. The alphanumeric text content data is processed using natural language processing techniques, such as a semantic vector analysis module using generative artificial intelligence. The vector analysis module builds a vector database to generate vectorized queries can be processed to identify the most relevant search results using neural networks. The processes performed by the disclosed systems and methods are not practically performed in the human mind and do not recite any method of organizing human activity.

To illustrate the voice note feature, generative artificial intelligence processes the alphanumeric text content data to create and store a Saved Search using the specified parameters. The agent voice note may state “Client is looking for a 4 bedroom, 2 bath home, in San Fran around $2 million. The text is vectorized and processed using artificial intelligence techniques to recognize the relevant parameters for creating a Saved Search that indicates “San Francisco, CA”, “4+ Bedrooms”, “2+ Bathrooms”, “Price range: <$2,000,000>.”

In another embodiment, the system can utilize image recognition technology to analyze content data that include images captured by the user computing device and transmitted to the provider system to determine the subject of the images, such as images relating to a particular type of room or feature of a home (e.g., images of a bathroom or outdoor pool area, etc.). The resulting information can be used to discern user preferences and processes utilizing artificial intelligence technology to determine listings of interest to particular end user.

To illustrate the foregoing feature with simplified examples, the system might determine that a particular user takes photographs of outdoor spaces with a higher frequency than other property features or that a user comments about renovation with a relatively high frequency. This content data of the image(s) are used as inputs to a neural network that generates outputs in the form of particular property listings that correspond to properties having larger or recently renovated outdoor spaces.

Those of skill in the art will appreciate that the foregoing examples are not intended to be limiting. The system can be configured to capture a wide variety of information about end users and end user activity utilized to implement and optimize system functionality.

### System Use and Navigation

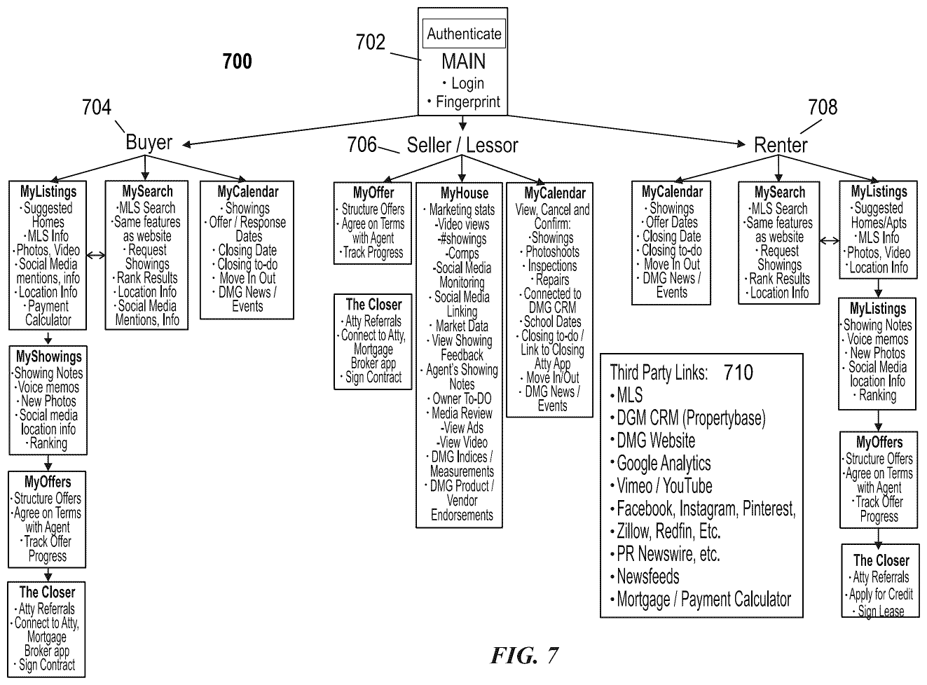

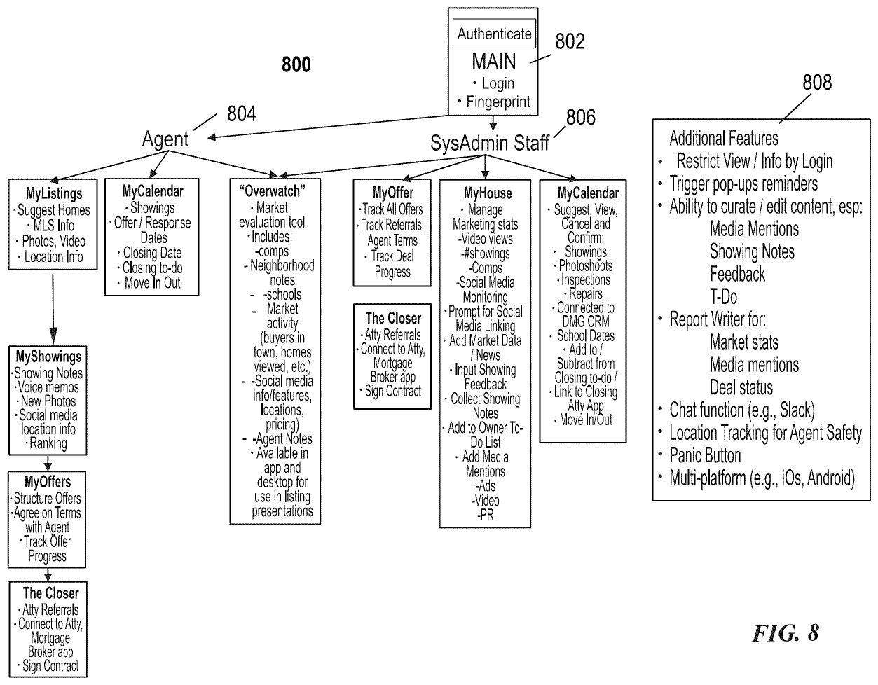

Overall system navigation of the provider mobile application is illustrated in FIGS. 7 and 8. Once users are registered to the provider system, users are presented with system tools and functions to facilitate the search and evaluation of products, services, and properties. The system implements artificial intelligence technology to enhance the accuracy and efficiency of system functions. The various system functions are discussed in more detail below with reference to the attached figures that depict example user interface screens available to end users through display on a user computing device.

In particular, FIG. 7 depicts technology platform functionalities 700 available via the provider mobile application. The technology platform functionalities 700 facilitate system navigation for buyers, sellers, and renters, and include authentication functionalities 702, buyer functionalities 704, seller/licensor functionalities 706, renter functionalities 708, and third party links 710. FIG. 8 depicts additional technology platform functionalities 800 facilitate system navigation for agents, system administrators, and staff that include authentication functionalities 802, agent functionalities 804, system admin/staff functionalities 806, and various other additional features 808.

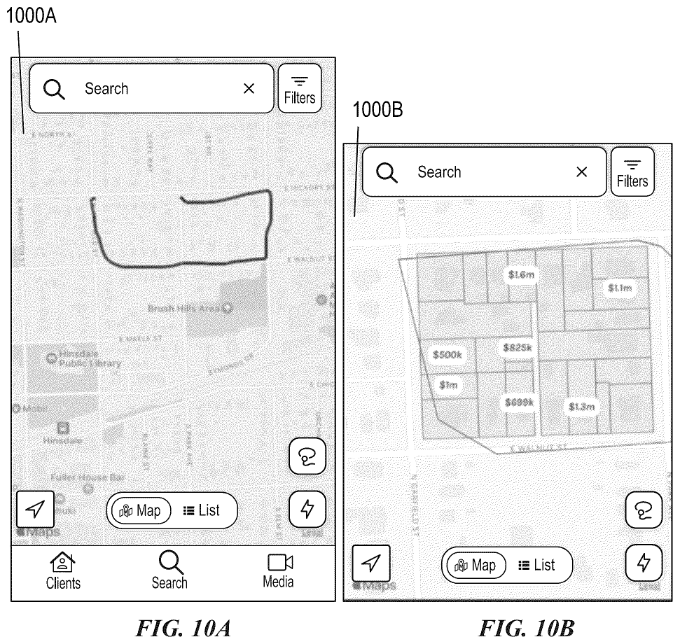

Turning to FIGS. 10A and 10B, users launch a provider mobile software application and navigate to one or more Map GUIs 1000A, 1000B that render a geographic map on the display of the user computing device. The map data used to generate the Map GUI(s) 1000A, 1000B can be received from the provider system or received through a Map API that interfaces with a third party system that generates and transmits map data (e.g., a Google® maps API).

The Map GUI(s) 1000A, 1000B shown in the attached figures include a search bar that accepts search data in the form of alphanumeric characters entered by an end user, such as a mailing address, postal zip code, or a city and state. As characters are input into the search bar, the system can transmit the characters to the provider system to identify potential matches that are used to automatically populate the search bar field as a user is entering the characters, such as auto filing the names “Chicago, Illinois” when the first three characters “Chi” are entered and the end user domicile data corresponds to a geographic area proximal to Chicago.

When the desired input characters are entered into the search bar, a user selects an initiate search input function, such as the magnifying glass icon shown at the left of the search bar depicted in FIGS. 10A and 10B. The search data entered by the end user into the search bar is transmitted to the provider system to identify property listings meeting the search data. The Map GUI(s) 1000A, 1000B also accepts graphical inputs from users, such as using a finger or mouse cursor to draw a line or geometric shape around a segment of a map. The system passes the graphical inputs from a user to an API or other software process that translates the inputs into geographic coordinate data representing geographic boundaries.

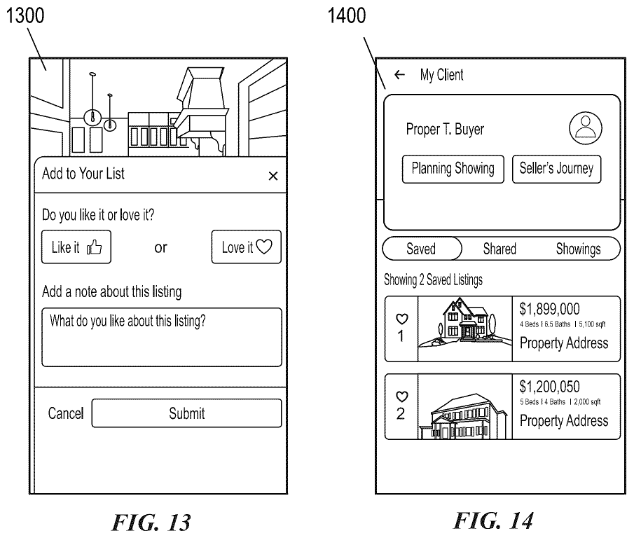

The geographic coordinate boundary data are passed to an API or system software process, such as a Listing API (see FIG. 12), that interfaces with a Listing Database, to return database records representing property listings corresponding to the geographic coordinate boundary data and that meet search data entered by a user in the search bar. Example search results are depicted in FIG. 10B where property listings are designated with a listing icon, such as an ellipsoid associated with a numerical amount that is a listing price. The listing icons are displayed as co-located with boundary lines of a property associated with the listing.

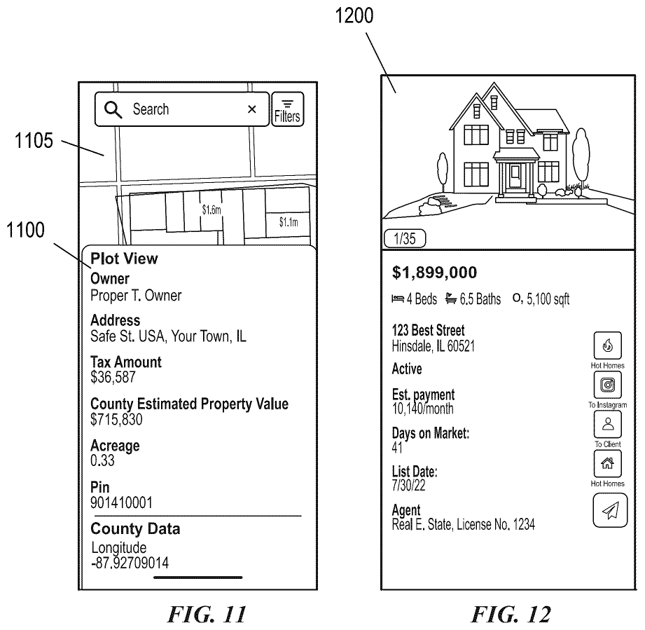

The property listing icons are implemented as a selectable input function that displays property listing data, as illustrated in FIGS. 11 and 12. Upon selection of a property listing symbol, the system passes selection data to an API, such as the Listing API and/or a Public Data API that interfaces with a public database to return property data. FIG. 11 illustrates a Plot View GUI 1100 rendered as a popup overlaid on the Map GUI 1105 that displays property data, such as the name of the property owner, the property address, the amount of taxes paid on the property, the size or area of the property in square feet or acres, geographic coordinate data, as well as other available property data.

Selecting a listing icon can also display property data in a Listing GUI 1200 illustrated in FIG. 12. The Listing GUI 1200 displays additional fields of property data, annotation data, and multimedia content data consisting of image data, audio data, or video data depicting or characterizing the property associated with the property listing. The Listing GUI 1200 can also be configured to display listing status data, such an indication that the sale of a property is pending, the duration of time a property has been offered for sale, and the name and contact information of an agent associated with the listing.

The Listing GUI 1200 includes input functions that permit users to enter listing annotation data. The listing annotation data are appended to, or associated with, the property data and stored to a relational database on the provider system. The listing annotation data and property data can further be associated with a particular end user or group of end users by, for example, storing the data as associated with a unique user identifier. Thus, when the property listing is displayed to a particular end user, or group of end users (e.g., an agent and one or more of the agent's clients), the annotation data are also displayed.

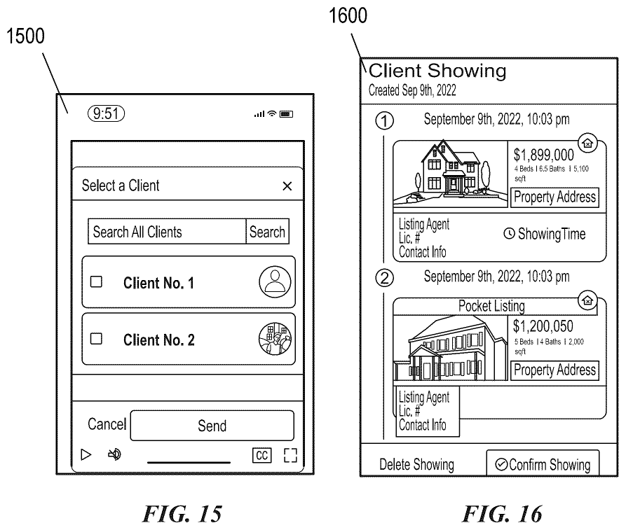

An example Annotation GUI 1300 is shown in FIG. 13 and includes a “Like it” and a “Love it” input function that allows users to indicate a sentiment and degree of sentiment polarity (e.g., a positive polarity of “Like It” or an even more positive polarity of “Love it”). The Annotation GUI also includes a text box input that receives alphanumeric content data or symbols entered by end users as well as inputs that allow end users to enter audio data (e.g., recorded voice messages), image data (e.g., photographs of a property), or video data that is associated with the property listing and property data.

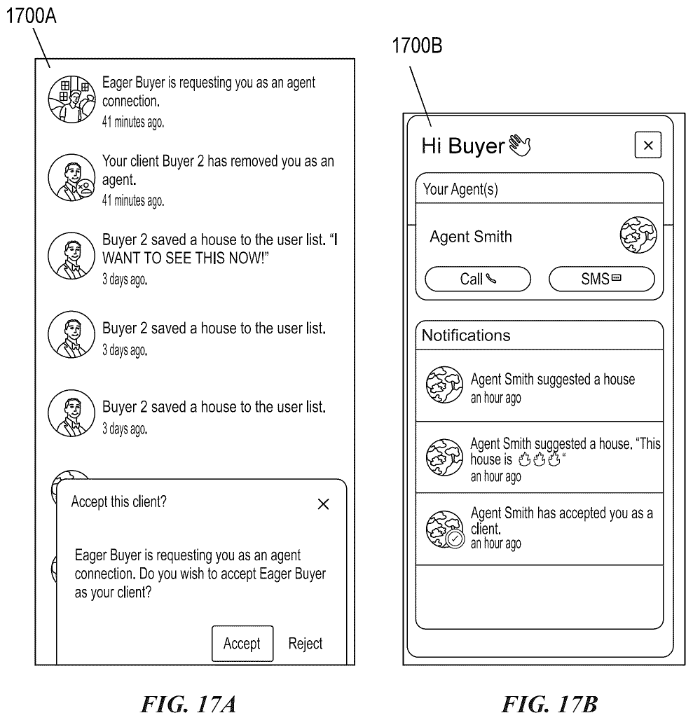

Turning again to the Listing GUI 1200 shown in FIG. 12, the Listing GUI can include input functions that permit an end user to save a property listing, share the property listing, or schedule an evaluation or “showing” of the property subject to the property listing. Saving a property listing associates the property listing with a particular end user account, such as saving a hyperlink or pointer to the property listing to a relational database on the provider system that also stores other elements of end user data. The property data and display data associated with the property listing are retrieved from the provider system for display on the user computing device when the user navigates to a Saved Listing GUI 1400, such as the example GUI shown in FIG. 14. The Saved Listing GUI 1400 includes hyperlinks or input functions for each saved property listing that navigate the user computing device to a Listing GUI 1200 that shows more detailed property data for each property listing. The Saved Listing GUI 1400 also displays a subset of property data, annotation data, and image data for each property listing for expedient identification and searching.

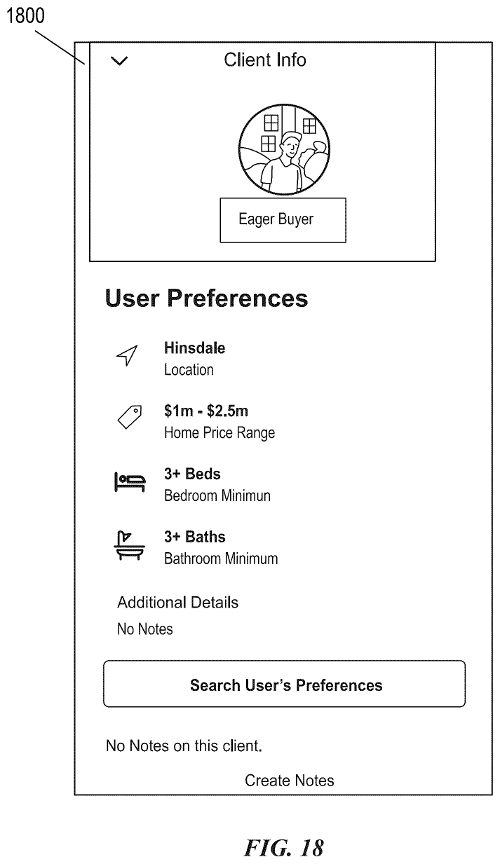

The Saved Listing GUI 1400 shown in FIG. 14 also includes input functions to display property listings that have been shared with other end users and to display scheduled property showings/evaluations. End users share a property listing or schedule a showing by first selecting a share input function or a schedule showing input function and then using the User Selection GUI 1500 shown in FIG. 15 to identify end users to receive a property listing or a showing request. The end user inputs alpha numeric search data into a text box on the User Selection GUI to search for other system users. Once a desired recipient end user is located, the recipient end user is selected through selecting a radio button, check box, or other input.

The property listing is sent or shared by selecting a “send” input function that instructs the provider system to transmit a hyperlink to the property listing to the selected recipient end user. The end user transmitting the property listing is optionally presented with input fields that allow the sending end user to enter annotation data to be sent along with the property listing.

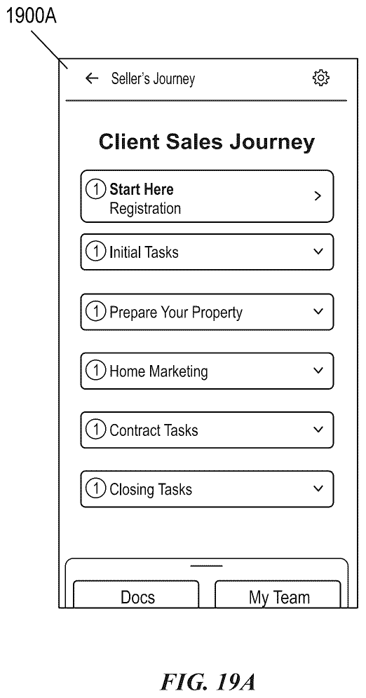

Property showings are initiated through a similar process where a sending end user selects one or more recipient end users to receive a showing request message. Before transmitting a showing request message, the user computing device can display a GUI that allows a sending end user to select dates and times for a showing as well as annotation data, such as pictures or a text message. The recipient end user optionally accepts or denies the showing request or proposes a new date and time. Once accepted, scheduled evaluation data are stored to the provider system where scheduled evaluation data can include time stamp or sequencing data, property data, and annotation data. FIG. 16 depicts an example Property Showing GUI 1600 where the recipient end user can accept or deny the showing request using a control input button.

The system transmits reminder notifications with information relating to the scheduled showing or evaluation, such as push notifications (e.g., sounds, icons displayed in a status or notification bar, etc.), popup notifications, emails, short message service (“SMS”) messages, or multimedia message service (“MMS”) messages. The reminder notifications can be generated by software applications or services integrated with the user computing device, such as a SMS-MMS software application or a notification service software application that generates push notifications.

The system can also include a Showing Scheduler API that interfaces with a third-party software application, service, or platform that performs scheduling and other functions relating to showings/evaluations. Through the Showing Scheduler API, the system sends and receives scheduled evaluation data such as date and time data, address or location data, user identification data, user email or phone number data, or property data, among other types of data and information. Third party applications, services, or platforms utilized for showings and evaluations can include, a calendaring software application or dedicated showing and evaluation software applications and services such as the ShowingTime™ mobile software application.

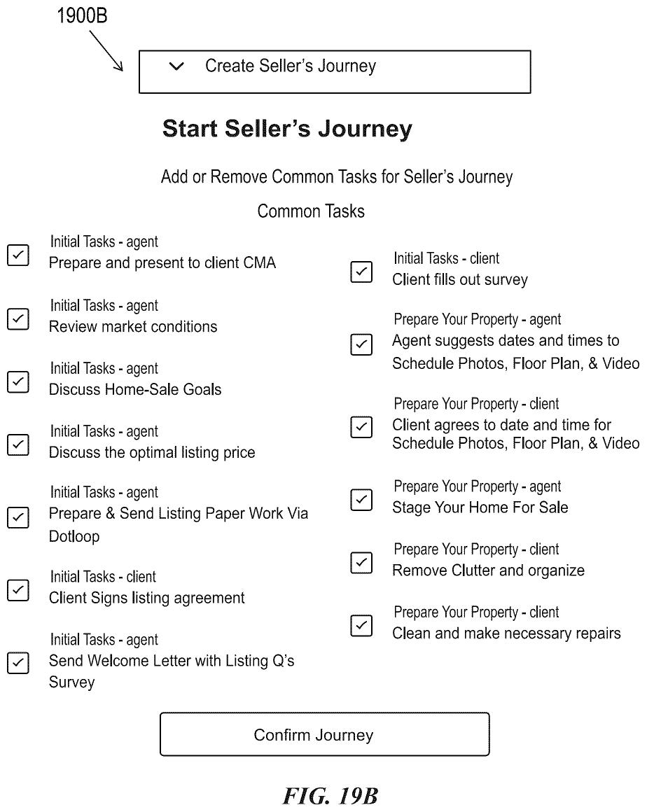

With respect to notifications, the present system can include one or more Notification GUIs 1700A, 1700B such as those shown in FIGS. 17A and 17B that display notification data in a list format. The notification data includes, but is not limited to, data relating to end user activity, received messages (e.g., a received property listing), and received requests generated by other end users. (e.g., a showing request message). The Notification GUI(s) 1700A, 1700B can include input functions that permit end users to take action in response to displayed notification data, such as accepting a received request to associate an agent intermediary with a buyer or seller end user (see FIG. 17A) or initiating a telephonic or written communication with another end user (see FIG. 17B).

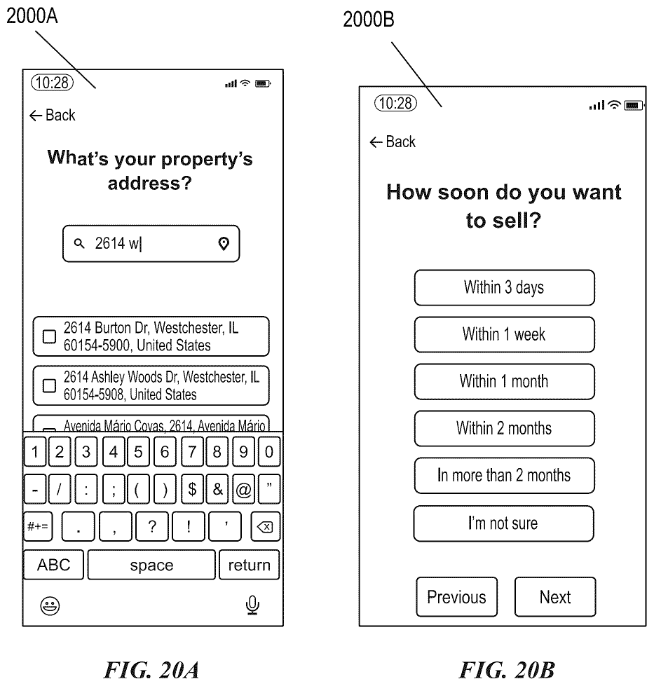

FIG. 18 illustrates an example User Information GUI 1800 that displays end user data, such as end user account data, preference data, or annotation data. The end user data displayed on a User Information GUI 1800 varies depending on the permissions data established for a particular end user. That is, an end user can edit account settings to customize end user data displayed to other system end users that can vary depending on the roles of such other end users. The system can also be configured with pre-defined permission data that establishes rules governing the particular elements of end user data are displayed to other users depending on the role of such other users.

Example application of permission data includes, but is not limited to: (i) permitting a limited subset of end user data to be viewable by all other end users of the technology platform (e.g. displaying a user first name to all users of the platform but not a last name); (ii) permitting a limited subset of end user data to be viewable by end users having specific role data (e.g., permitting first and last name, contact data, domicile data, and user preference data to be viewable by a connected end user with a role of “agent” so that agent intermediaries can view client end user data); or (iii) permitting all available end user data to be viewable by predetermined end users (e.g., allowing an end user living in the same household to view all end user data).

The User Information GUI 1800 can include other functions, such as the “Search User's Preferences” input function shown in FIG. 18 or a text box that permits entry of annotation data, such as user notes. Selecting the Search User's Preferences input function initiates a search of property listings having property data that corresponds to the user preference data for a given end user, such as searching for property listings associated with a specified geographic location or within a specified price range.

In some embodiments, the property listings returned and displayed as part of the search results can be optimized utilizing artificial intelligence technology. The platform includes a Prioritization Module implemented by one or more neural networks that analyzes end user data, activity data, preference data, browsing data, system configuration data, third-party data source, among other sources to analyze available resources (i.e., property listings) to determine a probability associated with each resource that an end user identified as a transfer source (i.e., a buyer) will initiate a transfer of a particular resource (i.e., purchase a property). The Prioritization Module can be installed and running on the provider system, the end user computing device, or a third party cloud service provider.

To illustrate the foregoing search prioritization, the provider system execute a search inputs based on user preference data (e.g., number of bedrooms, price, etc.), key words, or other criteria. The search inputs are passed to a provider database or third-party database including a plurality of resource database entries (i.e., property listings). The search results may return one-hundred (100) property listings that match the user preference data (e.g., 100 properties in a specific zip code and within the specified price range). The Prioritization Module processes property listings returned as part of the search results along with end user data to generate a probability that an end user will purchase, or at least schedule a showing for, each property listing within the search results. The system prioritizes the display of search results according to the determined probabilities so that the property listings having the highest probabilities are displayed higher on the search results list or displayed in a more conspicuous manner (e.g., displayed with a larger font, different color font, or with an icon or symbol indicating the listing is “preferred,” etc.).

With regard to connections between users, the system includes input functions that initiate the transmission of connection invitation request messages from one end user to another to establish links that correlate one or more end users. Connections can include correlating two buyer end users residing in the same household or correlating an agent end user with a buyer or seller end user. Once end users are connected, end user permissions are established providing an increased degree of communication and access to end user data. For instance, the system can be configured to permit end users to share a property listing or schedule a showing only with connected end users.

As a further example of connection operations, the system can permit the connection of one or more agent end users where, for example, the agent end users are employed by, or otherwise work for, the same business enterprise. Various agent end users can also be associated with distinct role data and permission data, such as: (i) end users associated with role data denoting the end user as a “senior agent” having access to view, create, and edit transaction/transfer data and property listings of all other associated agents in the same agency or enterprise; or (ii) end users associated with role data denoting the end user as a “junior agent” having access to view, create, and edit transaction/transfer data and property listings only for certain property listings and transactions.

In addition to the functions discussed above, the present systems and methods further facilitate optimizing the evaluation, analysis, disposition, transfer, or acquisition of interests in property, products, or services through work flow management functions and integrated, mobile customer relationship management functions (“CRM”), as discussed in more detail below.

### Workflow Management and CRM

The system includes interfaces that allow end users to initiate and manage work flows. The work flows can be customized according to each particular transaction or to the role of a user as a transfer source (seller), a transfer destination (buyer), or an intermediary (agent). The workflow is applied to manage the process of evaluating, analyzing, transferring, or acquiring an interest in property, products, or services. The workflows can establish and track action items, tasks, or steps required to facilitate a given transaction.

The actions items comprising the workflow can vary depending on the role of an end user as an agent, a buyer, or seller. For instance, a buyer or seller (but not an agent) might be required to complete action items such as modifying the property or securing monetary resources to complete a transaction whereas an agent (but not the buyer or seller) is required to complete action items that include generating the property listing. The workflow can also include differing action items depending on the nature of a transaction where, for example, conveyance of a lease does not require the action item of securing title insurance but transferring property ownership does require such action item.

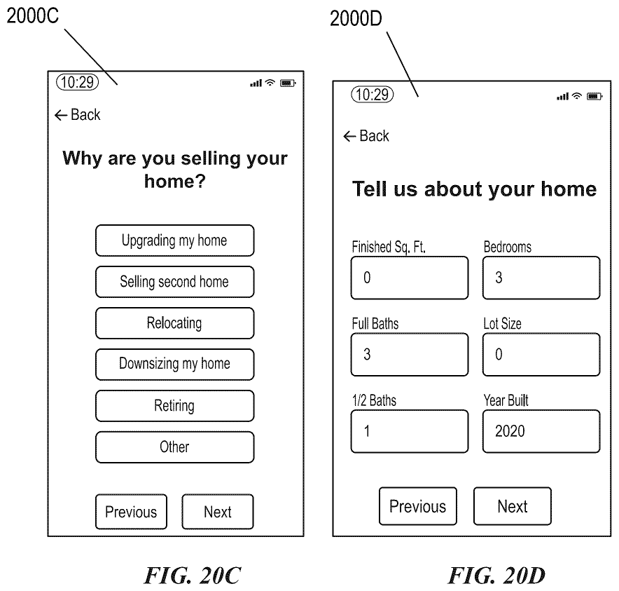

FIGS. 19A and 19B illustrate example Work Flow GUIs 1900A, 1900B that display a partial workflow for a transfer source (seller) or an agent facilitating a transaction for a transfer source. The Work Flow GUIs 1900A, 1900B shown in FIGS. 19A and 19B display an itemization of action items and categories of action items that are required for completing a transaction for the transfer of property. End users select an action item category to display a detailed listing of action items falling with the selected category. Action items can be associated with a narrative description of the action item as well as an action item status indicator, such as “not started,” “in progress,” “pending,” “incomplete,” “error,” or “completed.” The action item status indicator can be implemented as a change in color (e.g., red for “incomplete” and green for “complete”) or an icon (e.g., an “X” symbol for “incomplete” or a checkmark for “completed”). End users can edit, add, or remove action items and action item categories to customize a workflow for a particular end user, group of end users, or a specific transaction. As a workflow progresses and action items are completed, end users can edit the associated action item status.

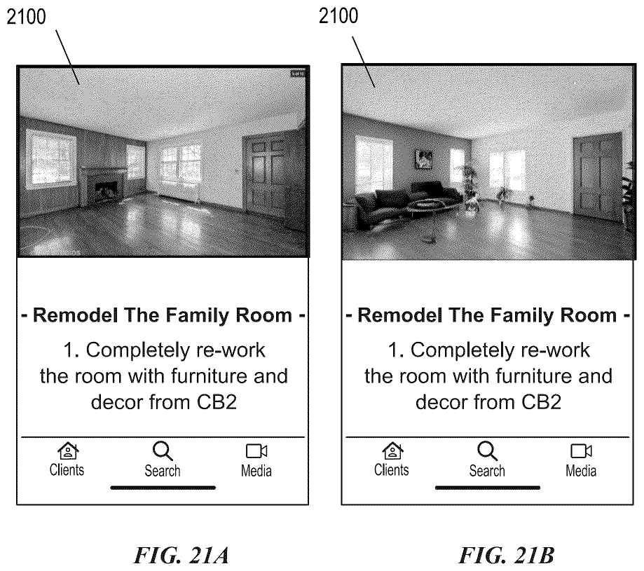

FIGS. 20A through 20D depict example Create Work Flow GUIs 2000A, 2000B, 2000C, 2000D that are used for initiating a work flow from the perspective of a transfer source end user or an agent end user. The system presents the end user with a series of input functions prompting the end user to enter data and information relating to a particular transaction, such as: (i) a property address (see FIG. 20A); (ii) a duration for completing the work flow and transaction (see FIG. 20B); (iii) transaction motivation data characterizing the underlying reason for initiating a transaction (see FIG. 20C); (iv) residential data characterizing property subject to the transaction, such as the number of bedrooms, bathrooms, square footage area, or year constructed (see FIG. 20D); and (v) any other property data or end user data useful for facilitating a transaction. The data input into the system are used to generate a workflow and/or a property listing subject to the workflow.

The system further provides CRM functions that allow end users to access, search, evaluate, review, modify, delete, add, and utilize various elements of transaction/transfer data, end user data, and property data. The transaction/transfer data can include, without limitation: (i) a time and date a transaction was completed; (ii) a duration required to complete a work flow underlying a transaction; (iii) a unique transaction number or other identifier; (iv) a resource value or sale price of a transaction; (v) identifiers (i.e., names) for buyer, seller, or agent end users involved in the transaction; (vi) end user data, such as contact data and demographic data, for the end users involved in a transaction; (vii) property data characterizing the property subject to the transaction; (vii) transaction category data characterizing the type of transaction, such as a sale, lease, etc.; (ix) annotation data that includes human-readable messages describing the end users or property subject to a transaction; and (x) any other data useful for characterizing the transaction.

The transaction/transfer data are stored to a relational database on the provider system or to a third-party system, such as a SaaS or PaaS provider. Agent end users operate a user computing device to call a software process or API that interfaces with the provider or third party system to access, review, download, analyze, modify, add, delete, or utilize the transaction/transfer data. In this manner, agent end users can access data relating to current and former clients, property listings, and sales facilitated by a given agent or other agents within the same enterprise or group.

In addition to transaction/transfer data, the system can capture data from numerous other third party sources that are used to enhance and optimize features available to end users for facilitating the evaluation and transfer of property, products, and services. Additional third-party market data sources and types can include, without limitation: (i) privately created or publicly available market data (e.g., housing “start” data published by a government agency or private company indicating the volume of new homes constructed in a given geographic area); (ii) cost of living index data published by a government agency; (iii) census data reflecting changes in the number of individuals living in a given geographic area along with demographic information for such individuals, such as income, family size, etc.; (iv) interest rate data; (v) market data for private companies within a property-related industry, such as sales volumes or stock prices for home builders, building material suppliers, or moving companies, among others; (vi) government data for building permits applied for or issued in a given geographic area; (vii) the location and volume of wireless data towers erected in a geographic area; (viii) publicly available school enrollment data; (ix) weather data; (x) reported sales of consumer goods; (xii) publicly reported crime statistics; (xiii) social medial sentiment as determined using natural language processing technology; and (xiv) published news feeds as analyzed through natural language processing technology to determine subjects addressed in the news and the sentiment of news articles.

End users can access the transaction/transfer data, end user data, property data, and market data to conduct targeted searches for end users or property listings meeting specified criteria or search data. This in turn allows agent end users to perform a wide variety of functions and operations that include, without limitation: (i) matching buyer end users with property listings that satisfy end user preference data; or (ii) develop customized communications to specific categories of end users for marketing or other purpose. For instance, an agent end user can submit a search query that returns a list of end users with user preference data indicating that the end user is seeking to purchase property in a given geographic area having a specified price range. The agent end user can generate an email communication or schedule showing message that invites end users listed in the search results to a property showing or “open house” for one or more properties that meet the geographic location and price criteria.

The system can include a Targeted Communication GUI that allows end users to generate targeted communications that include human-readable text, image data, video data, hyper-links, or selectable input functions, among other features. In some embodiments, the system incorporates an API that interfaces with a third-party system used for generated targeted communications, such as a word processor software application or a direct marketing communication technology platform.

The system further utilizes artificial intelligence technology to optimize the content and recipients of a targeted communication. Continuing with the immediately preceding non-limiting example, the system processes the search results using the Prioritization Module where the search results include a list of end users having user preference data meeting specified geographic data and price range parameters (or other user preference data parameters). The end user data for each of the end users in the search results, the property data for one or more property listings, and/or the transaction/transfer data from a CRM database, are input to a neural network that determines probabilities that each end user in the search results will purchase or schedule a showing for a particular property. The neural network can determine, for instance, that end users aged fifty years or older are more likely to purchase a given property, and, therefore, end user age has a higher weight as a factor in the neural network. The end user search results are then prioritized according to user age or other factors (e.g., end user income, family size, etc.). The agent end user can thus select recipients for a targeted communication that are associated with higher probabilities of making a purchase or scheduling a showing.

The system can also rely on artificial intelligence technology to generate optimized targeted communication content. For instance, a neural network analysis might determine that a group of end users included in the foregoing search results have a higher probability of scheduling a showing if a targeted communication incorporates particular content, such as photographs of a backyard space or text content highlighting nearby points of interest for a property (e.g., restaurants, sports venues, etc.). The system can be configured to display to the agent end user particular communication content that increases the probability recipients of the communication will schedule a showing, thereby optimizing the targeted communication.

To supplement targeted communications generated by an end user, the provider system can be configured to automatically generate targeted communications based on end user data, transaction data, property data, or market data, among other sources. The automated targeted communications can be transmitted to user computing devices through text message, email, push notifications, or notifications displayed within a provider mobile application.

The automated targeted communications can be generated upon detection of predefined conditions, such as end user data indicating the end user experienced a life event or change in occupational status or location. The targeted communication can include property listings that meet user preference data or property listings within a defined geographic region proximal to the end user's current location or proximal to the expected location where the end user will relocate as a result of a change in occupational status or position.

As with end user generated targeted communications, the system uses artificial intelligence technology to identify property listings associated with a significant probability that the end user will purchase the property or schedule a showing. That is, the system processes the property data and end user data to determine probabilities that an end user will purchase or view a particular property. The automated targeted communication can incorporate property listings with the highest probabilities or with probabilities above a defined threshold (e.g., all property listings having a 50% probability or higher of the end user scheduling a showing).

The provider system and mobile application includes an agent dashboard GUI (not shown) that allows agent end users to create property listings, view property listings, view marketing metrics, and view end user data associated with the agent's clients. The system also provides an end user dashboard that similarly allows buyer or seller end users to view a property listing for property owned by the end user along with associated marketing metrics. The agent or end user dashboard GUI display the types of marketing and advertising used to promote each particular property listing (e.g., social media posts, videos published to the Internet, or a provider website).

The dashboard GUIs can further display marketing metrics, such as the number of views, comments, or reactions (e.g., a “like”) that a particular social media post or published property listing has received. Based on the marketing metrics, the provider system provides end users with recommendations for modifying the type and content of social media posts or advertising, such as recommending that a property listing be published to a particular social media platform, that a video within an advertisement be shortened, or that more pictures be included showing a specific property feature.

Such recommendations can be determined using artificial intelligence technology that determines content and types of marketing that are associated with higher probabilities of generating interest for a particular listing. The system utilizes property data, transaction data, marketing metrics, and end user data for individuals that viewed, commented on, or reacted to, a particular advertisement or social media post. A neural network output might determine, for instance, that: (i) a particular property listing has a high probability of being purchased or viewed by a younger end user; and (ii) younger end users are more likely to purchase or schedule a showing for a property that includes a video less than 20 seconds long and that is published on Instagram®. The system, therefore, generates a notification to an agent end user recommending that the particular property be advertised on Instagram and include a link to a short video. Those of skill in the art will recognize that the above example is not intended to be limiting, and the system can be configured to generate numerous other types of recommendations.

### Additional Evaluation Tools and Functions

In addition to the variety of features discussed above, the system includes other tools and features that facilitate end user evaluation and analysis of property, products, or services. Additional tools include a virtual staging tool, an online publication tools, an analytical report tool, content notification data feeds, and a DMG index tool.

The virtual staging tool is a software tool that utilizes artificial intelligence and natural language processing technology to generate modified image data based on input in the form of human-readable text or linguistic instructions. The end user launches the virtual staging tool and selects image data to load into the tool, such as a digital photograph of an indoor or outdoor space within a property (e.g., a bedroom, family room, or backyard). The end user inputs staging instructions in the form of written or voice expressions that describe one or more design elements, or in other embodiments, the staging instructions can be example images of various design elements. The virtual staging modifies the image data according to the staging instructions in a manner that renders the modified image data with a “life-like” appearance. The modified image data can be uploaded to the system as annotation resource image data associated with a listing, incorporated with a property listing, transmitted to other system users as part of sending a listing, or published to a social media platform or website, among other uses.

The staging instructions can address design elements such as flooring, wall or other surface paint colors, light figures, decorative elements like paintings or sculptures, bric-a-brac (e.g., miscellaneous collection of small articles commonly of ornamental or sentimental value), appliances, furniture, or structural elements, such moving, removing, or modification of walls, pillars, columns, built-in shelving, kitchen islands, among others. In other embodiments, the staging instructions can comprise a description of a particular style, such as “contemporary,” “rustic,” “farmhouse,” “industrial,” “Bohemian,” among innumerable other types of styles. The staging instructions can further action elements such as instructions to “re-work” a room, “replace” particular design elements, or “update” specified design elements.

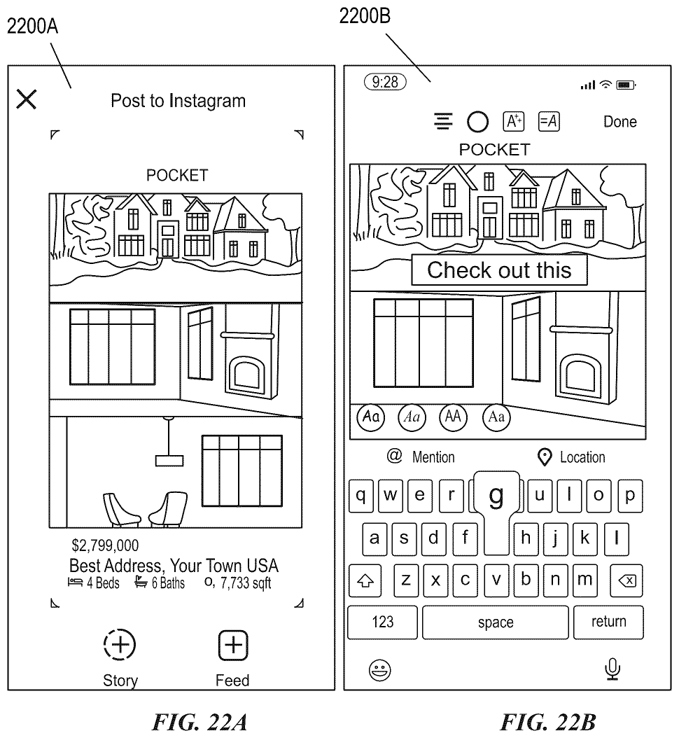

Operation of the virtual staging tool 2100 is depicted in FIGS. 21A and 21B where the end user first loads image data that depicts a photograph of a family room within a residential property. The end user then inputs staging instructions to “re-work” or modify the appearance of the image data by including furniture and décor from a specified retailer. The virtual staging tool 2100 utilizes a neural network model to modify the image data to depict the family room as having the specified style of furniture and décor. Skilled artisans will appreciate that the virtual staging tool 2100 can modify image data according to almost innumerable other factors and criteria in addition to specified furniture and décor, including, without limitation, modifying the color of a room, changing appliances, moving a structure (e.g., moving, removing, or expanding a kitchen island or a window), or changing flooring materials and color.

The neural network used to implement the virtual staging tool 2100 is trained using image data collected from various sources, such as websites for furniture retailers, home décor retailers, appliance retailers, building material suppliers, social media platforms, artisan or customized goods retailers (e.g., Pinterest®), among other sources. The image training data is input into the neural network to generate annotated resource image data, which is then compared against known resource image data to generate error data, which is a difference between the generated annotated resource image data and the “expected” annotated resource data. The parameters of the neural network are adjusted to minimize the error rate.

The neural network is implemented by, or integrated with, the provider system or called through an API that interfaces with a third-party system. The virtual staging tool 2100 permits end users to visualize how a specific room or other three-dimensional space would appear if modified according to end user preference, thereby substantially enhancing end user ability to evaluate a particular property.

The virtual staging tool 2100 is implemented with text-to-image software processing technology, such as the Stable Diffusion™ software available through Stability AI, Ltd., the DALL-E™ software created by OpenAI™, the Imagen™ software created by Google®, the Dreambooth™ software developed by Google®, and the Lensa™ software created by Prisma™. Text-to-image tools can utilize diffusion software models that generate images by adding noise to a set of training images with each training image each paired with text. The diffusion software model then removes the noise to construct the desired image. In one example, diffusion models incorporated within the Stable Diffusion tool are trained by removing successive applications of Gaussian noise from training images gathered from the Internet where each training image is paired with a text caption. The Stable Diffusion software tool includes (i) a variational autoencoder (“VAE”); (ii) a U-Net module; and (iii) an optional text encoder module. The VAE encoder compresses image data from pixel space to a smaller dimensional latent space. Gaussian noise is iteratively applied to the compressed latent representation during forward diffusion. The U-Net block, composed of a Residual Network (ResNet) neural network foundation, removes noise from the output of forward diffusion to obtain latent representation. Finally, the VAE decoder generates the final image by converting the representation back into pixel space.

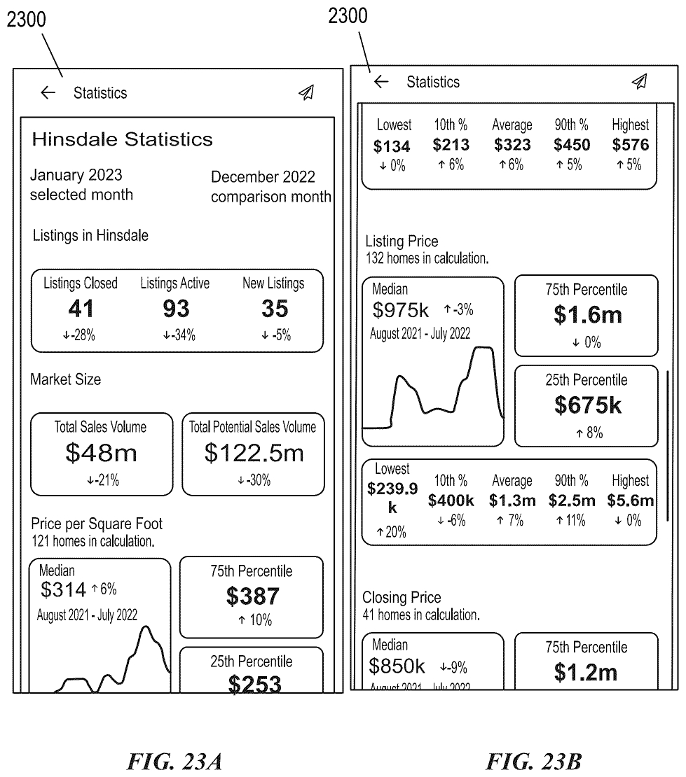

Turning to the example Posting GUIs 2200A, 2200B shown in FIGS. 22A and 22B, the system can also incorporate online publication tools that allow end users to expediently publish property data and/or property listings to the Internet. The system can publish property data to a website hosted by the provider or to a third-party technology platform, such as a social media platform.

To publish property data to a social media platform, the online publication tool captures property data from a property listing and interfaces with an API that formats the property data in a manner suitable for publication to a particular social media technology platform. End users can incorporate annotation data, such as comments and captions or image data, as illustrated in FIG. 22B, prior to publishing the property data to the social media technology platform. This allows end users to publish property listings in a manner that is viewable to pre-existing audiences of individuals utilizing the particular social media platform.

In one embodiment, the system utilizes artificial intelligence and natural language processing technology to optimize social media publications. Similar to the targeted communications example discussed above, the system can utilize a neural network to determine probabilities that particular content data, such as text comments or images, will result in end users being more likely to purchase a property, schedule a showing, or send a message to the end user that published the property listing to social media. Examples can include neural network outputs indicating that photographs of a property landscaping in a given geographic area or for a home in a given price range increases the probability that end users will contact the end user that published the social media post. Prior to publishing a property listing, the system suggests content data to include in the post to increase the probability of receiving end user responses.

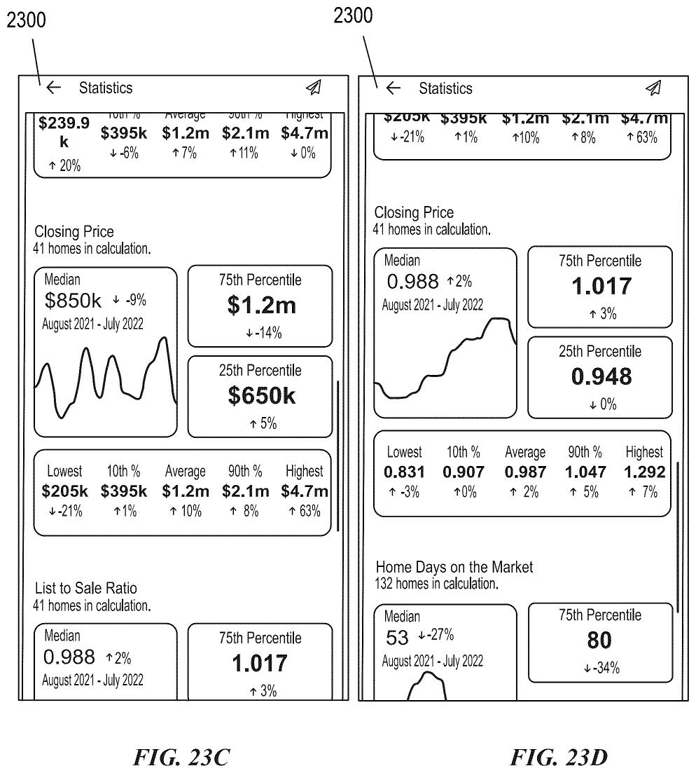

The system also incorporates an analytical report tool that calculates and displays a wide variety of analytical insight data useful for evaluating a property listing. FIGS. 23A to 23D illustrate an example Analytical Report GUI 2300 that displays a customized report including analytical insight data in numerical format with short captions and text descriptions as well as graphs depicting analytical insight data. The system includes input functions that allow end users to generate a report, print a report, save a report to memory, transmit a report to one or more end users, and/or publish a report to a website, the provider platform, or to a social media platform.

To generate the analytical reports, end users input one or more analytical report parameters that are used by the system to format a report, search, and sort underlying data that are processed to generate the report. Example analytical report parameters include, but are not limited to, specifying: (i) a geographic area by city, state, or zip code; (ii) sequencing data, such as a start date and end date for gathering and processing property data and transaction data and calculating analytical insight data (i.e., data are processed over a specified date range); (iii) a specific property listing and related property data for analysis; or (iv) the analytical insight data fields to include in a report. The system utilizes the analytical report parameters to capture data from the provider system or various third party sources, including: (i) transaction data; (ii) end user data; or (iii) property data captured from a provider database, a government maintained database (e.g., a local property appraiser, tax collector, or county recorder), or a private database of property data (e.g., the Multiple Listing Services or MLS).

The analytical reports, such as the example report provided by the Analytical Report GUI 2300 shown in FIGS. 23A to 23D, can be configured to include a wide variety of analytical insight data, such as: (i) a market size in dollar value of properties sold in a particular region or a specified date range; (ii) a median price per square foot of properties sold in a particular region or over a specified date range; (iii) median listing price in a given geographic area over a specified time period or listing prices at specified percentile thresholds (e.g., 10th percentile, 25th percentile, 75th percentile, etc.); (iv) median closing price in a given geographic area over a specified time period or closing prices at specified percentile thresholds; (v) the average duration to complete a work flow (e.g., “days on the market”) in a given geographic area over a specified time period; (vi) the average or median tax assessments for properties in a given geographic area over a specified time period; and (vii) various other analytical insight data useful for evaluating properties.

The system can utilize artificial intelligence technology to determine predictive analytical insight data that discerns and predict patterns in transaction data, end user data, or property data underlying a report. As one example, the system processes property data and transaction data in a particular geographic area to predict the duration for completing a work flow at specified listing prices (i.e., how soon will a property sell at a given price). The end users generates property listings or modify work flows using data-based results to optimize the evaluation and marketing relating to the patents at issue.

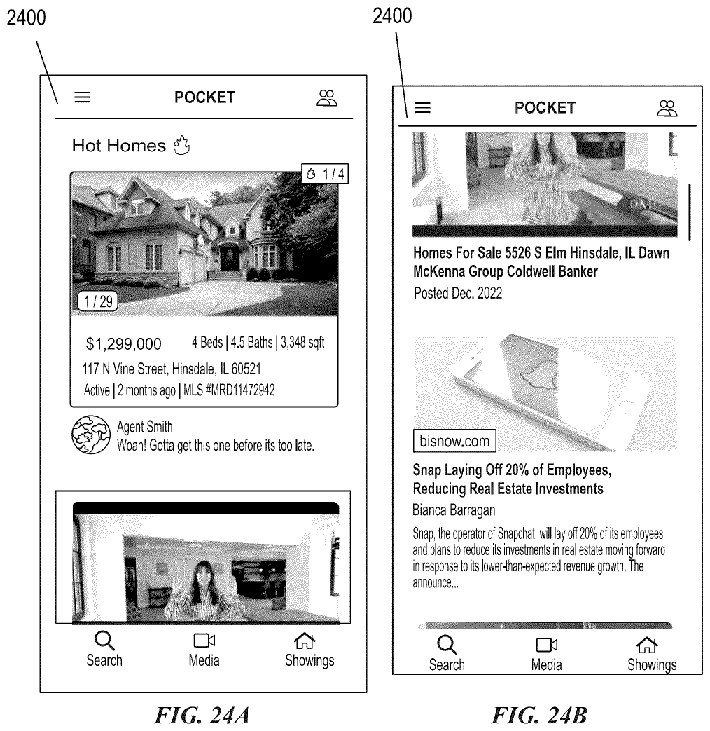

Turning to FIGS. 24A and 24B, the system includes a content notification data feed 2400 that displays discrete content postings. Content postings can be updated at periodic intervals, such as every hour or once per week. Alternatively, the content notification data feed 2400 can be updated asynchronously to display new content postings as they are generated and uploaded to the provider system. The content postings can be generated by other end users of the provider platform and uploaded to the provider system for transmission and display to other end users. Alternatively, the system can pull content postings from third-party websites or technology platforms, such as capturing hyperlinks to news articles or postings to third-part social media platforms that are displayed within the provider mobile software application.

The content postings include, among other things: (i) news articles; (ii) blog articles; (iii) recently created property listing; (iv) previously published property listings that have been updated; or (v) property listings that receive a predetermined number of views or end user “likes” indicating that the property listing is drawing attention and might be of interest to a broader audience of provider platform end users. The content postings can comprise a summary of the underlying information, such as a single “cover” photograph of a listing along with a price, or a single photograph from a news article and the first two lines of the news article. The content postings can include a hyperlink or other function that, when selected, navigates the user computing device to a website or a GUI within the provider mobile application that displays more data and information about the content posting.

The content notification data feed 2400 can be generated and customized with artificial intelligence technology to include content postings that have higher probabilities of being of interest to a given end user. The system processes end user data and content postings to determine, for example, the probabilities that an end user will select and view particular content postings. The system then displays a predetermined number of content postings having the highest probabilities of being selected by an end user. The system can also display content postings according to predefined filter parameters, such as transmitting to an end user computing device (i) all property listings that match a geographic area specified in the end user preference data as being a geographic area of interest where the end user is seeking to purchase property, or (ii) all news articles relating to a particular subject selected by the end user.

In some embodiments, the system can include a DMG index that utilizes artificial intelligence technology to generate actionable insights transmitted to end user computing devices. The DMG index utilizes numerous types of data captured by interfacing with various data sources, including, but not limited to: (i) transaction data from a provider system or third-party CRM system; (ii) end user data; (iii) privately created or publicly available market data (e.g., housing “start” data published by a government agency or private company indicating the volume of new homes being constructed in a given geographic area); (iv) a cost of living index published by a government agency; (v) census data reflecting changes in the number of individuals living in a given geographic area along with demographic information for such individuals, such as income, family size, etc.; (vi) current interest rate data; (vii) market data for private companies within a property-related industry, such as sales volumes or stock prices for home builders, building material suppliers, or moving companies, among others; (viii) government data on the number of building permits applied for or issued in a given geographic area; (ix) the location and volume of wireless data towers erected in a geographic area; (x) publicly available school enrollment data; (xi) weather data; (xii) reported sales of consumer goods; (xiii) publicly reported crime statistics; (xiv) social medial sentiment as determined using natural language processing technology; and (xv) published news feeds as analyzed through natural language processing technology to determine subjects addressed in the news and the sentiment of news articles.

The DMG index generates DMG actionable insight data transmitted to end user computing devices where the actionable insight data are customizable and dynamically generated to be targeted to specific end users. The DMG actionable insight data can include a numerical score or a graphical indicator, such as symbols with varying colors that are transmitted to end users for display. The DMG actionable insight data may further include human-readable, narrative content data providing context for end users.

The DMG actionable insight data can provide actionable insights that include, without limitation, notification that: (i) market conditions are favorable or unfavorable for a particular end user to sell property owned by the end user; (ii) market conditions are favorable or unfavorable for a particular end user to purchase property that matches the end user preference data, such as purchasing property having a specific size, in a given geographic area, or within a specified price range; (iii) market conditions are favorable or unfavorable for an end user to renovate a property owned by the end user. The DMG actionable insight data can be transmitted to user computing devices as a text message, push notification, email, or other electronic communication. The communication can include a hyperlink or other function that navigates the user computing device to a webpage or GUI displaying additional information about the received actionable insight.

The functionality of the DMG index can be illustrated with the following simplified examples. Those of skill in the art will appreciate that the foregoing examples are not intended to be limiting, and a wide variety of other actionable insights can be generated by the system. In one embodiment, the system processes end user data indicating that the end user owns a property with a specific feature or size, such as a home with a pool and four bedrooms. The system also processes transaction data indicating that properties with a pool and four bedrooms are selling faster and for higher prices than comparable homes in a geographic area. The system can utilize artificial intelligence technology to determine a probability that property owned by a given end user that meets the above criteria will sell for a specified percentage above the median property sale price for a given geographic area. The system thus notifies the given end user that market conditions are favorable for the end user to sell a particular property owned by the end user and that the end user may expect to receive a favorable sale price for the property.

As another example, the system can process transaction data, CRM data, and census data to determine that individuals within a specific age range (e.g., twenty to thirty years of age) and having employment within a specific industry (e.g., medical professionals), are purchasing property at increasing frequency in a given city. The system also processes end user data to identify end users meeting the foregoing age and professional employment criteria. The system then sends DMG actionable insight data to the identified users providing notification that conditions are favorable for the end users to consider purchasing property in the given city.

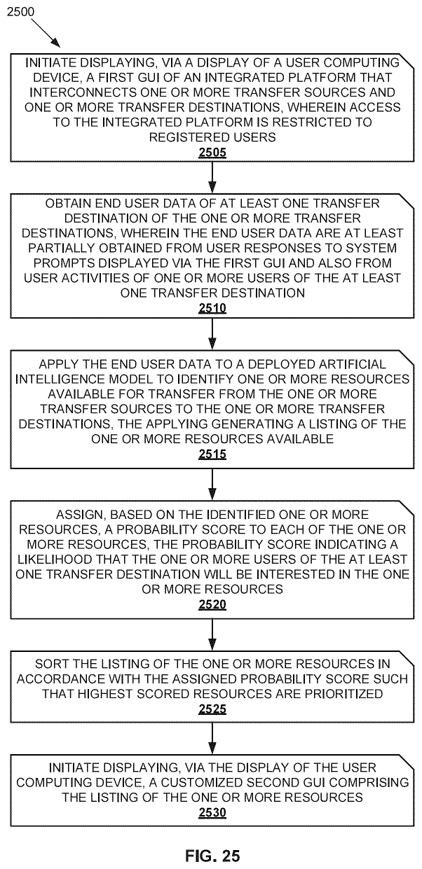

FIG. 25 is a block diagram of an example method 2500 for integrated platform graphical user interface customization, according to one embodiment. At block 2505, the system initiates displaying, via a display of a user computing device, a first GUI of an integrated platform that interconnects one or more transfer sources (e.g., a seller, lessor for a rental, and/or any entity or individual having an ownership interest or a right to lease) and one or more transfer destinations (e.g., a prospective buyer, a prospective lessee, and/or any entity or individual seeking to acquire an ownership interest or a right to lease), wherein access to the integrated platform is restricted to registered users. In some embodiments, the interest may be an ownership interest that would be transferred.

At block 2510, the system obtains end user data of at least one transfer destination of the one or more transfer destinations, wherein the end user data are at least partially obtained from user responses to system prompts displayed via the first GUI and also from user activities of one or more users of the at least one transfer destination. According to various embodiments, the end user data includes end user account data, navigation data, system configuration data, and activity data. In some embodiments, the end user data includes end user account data, the end user account data including at least one selected from the group consisting of (i) a unique user identifier (ii) user domicile data, (iii) user contact data, (iv) user demographic data, (v) user occupational data, (vi) user household data, (vii) user residential data, (viii) user interest data, and (ix) end user role data. In some embodiments, the end user data includes navigation data, the navigation data including at least one selected from the group consisting of (i) navigation history data, (ii) redirect data, and (iii) search history data. In some embodiments, the end user data includes system configuration data, the system configuration data including at least one selected from the group consisting of (i) a unique identifier for the user computing device, (ii) a MAC address for a local network of the user computing device, (iii) copies of key system files that are unlikely to change between instances when a provider system is accessed, (iv) a list of applications running or installed on the user computing device, and (v) authentication data for authenticating the user computing device. In some embodiments, the end user data comprises activity data, the activity data including at least one selected from the group consisting of (i) time and date data, (ii) an event identifier of activity represented by event data; (iii) an event type indicating a category of activities represented by an event, (iv) an event source identifier identifying a software application or hardware device originating the activity data, (v) an endpoint identifier, and (vi) characterizing data characterizing the event.

At block 2515, the system applies the end user data to a deployed artificial intelligence model to identify one or more resources (e.g., a full or partial interest in a product, a property (real property or personal property), and/or a service) available for transfer from the one or more transfer sources to the one or more transfer destinations, the applying generating a listing of the one or more resources available. At block 2520, the system assigns, based on the identified one or more resources, a probability score to each of the one or more resources, the probability score indicating a likelihood that the one or more users of the at least one transfer destination will be interested in the one or more resources. At block 2525, the system sorts the listing of the one or more resources in accordance with the assigned probability score such that highest scored resources are prioritized. At block 2530, the system initiates displaying, via the display of the user computing device, a customized second GUI comprising the listing of the one or more resources.

In some embodiments of the method 2500, a request is received from the user computing device to access a listing GUI of a resource of the one or more resources, and the system initiates displaying, via the user computing device, the requested listing GUI, where the listing GUI depicts (a) fields for representing and receiving property data, annotation data, and multimedia content data, wherein the content data are selected from the group consisting of image data, audio data, and video data that characterize the resource of the listing GUI, (b) listing status data, and (c) contact information of one or more intermediaries associated with the resource.

In some embodiments of the method 2500, a request is received from the user computing device to access a workflow GUI that displays at least a partial workflow for transferring a resource of the one or more resources to the one or more transfer destinations from the one or more transfer sources, and the system initiates displaying, via the user computing device, the requested workflow GUI depicting an itemization of action items, action item status, and categories of the action items that are to be completed to effectuate transfer of the resource.

In some embodiments of the method 2500, a request is received from the user computing device to access a series of Create Work Flow GUIs used to initiate a work flow of a transfer of a resource of the one or more resources, the series of Create Work Flow GUIs facilitating data entry related to the transfer, wherein data to be entered via the Create Work Flow GUIs includes at least one selected from the group consisting of (i) a property address, (ii) a duration for completing the work flow, (iii) motivation data characterizing an underlying reason for initiating the transfer; and (iv) residential data characterizing the resource subject to the transfer. Further, the system initiates displaying, the user computing device, the requested series of Create Work Flow GUIs. In some embodiments, entered data provided via the data entry is stored to a relational database as transfer data. The transfer data may include, according to various embodiments, at least one selected from the group consisting of (i) a time and date to effectuate the transfer, (ii) a duration required to complete the work flow, (iii) a unique transfer identifier, (iv) a resource value of the resource, (v) identifying information of one or more transfer sources and the one or more transfer destinations, (vi) end user data, (vii) resource data characterizing the resource, (vii) category data characterizing the transfer, and (ix) annotation data.

In some embodiments, the method 2500 includes generating one or more actionable insights to be distributed to at least one of the one or more transfer sources and one or more transfer destinations. The one or more actionable insights may be generated using actionable insight data that includes at least one selected from the group consisting of (i) transferring market conditions data indicating market conditions are favorable or unfavorable for a resource transfer of a resource associated with the one or more transfer sources, (ii) receiving resource market condition data indicating the market conditions are favorable or unfavorable for obtaining a new resource that matches end user preference data, and (iii) renovation market condition data indicating the market conditions are favorable or unfavorable for to renovate a resource of the one or more transfer sources.

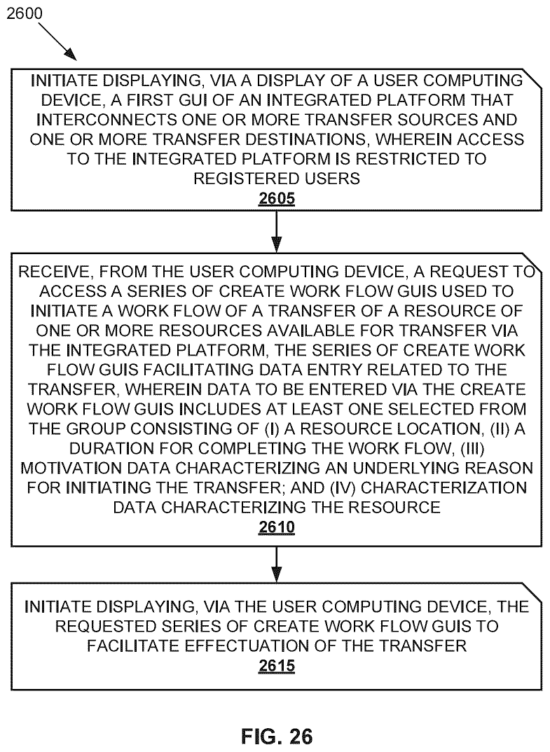

FIG. 26 is a block diagram of an example method 2600, according to one embodiment. At block 2605, the system initiates displaying, via a display of a user computing device, a first GUI of an integrated platform that interconnects one or more transfer sources and one or more transfer destinations, wherein access to the integrated platform is restricted to registered users. At block 2610, the system receives, from the user computing device, a request to access a series of Create Work Flow GUIs used to initiate a work flow of a transfer of a resource of one or more resources available for transfer via the integrated platform, the series of Create Work Flow GUIs facilitating data entry related to the transfer, wherein data to be entered via the Create Work Flow GUIs includes at least one selected from the group consisting of (i) a resource location, (ii) a duration for completing the work flow, (iii) motivation data characterizing an underlying reason for initiating the transfer; and (iv) characterization data characterizing the resource.

According to various embodiments, entered data provided via the data entry is stored to a relational database as transfer data. The transfer data includes, according to various embodiments, at least one selected from the group consisting of (i) a time and date to effectuate the transfer, (ii) a duration required to complete the work flow, (iii) a unique transfer identifier, (iv) a resource value of the resource, (v) identifying information of one or more transfer sources and the one or more transfer destinations, (vi) end user data, (vii) resource data characterizing the resource, (vii) category data characterizing the transfer, and (ix) annotation data.

According to various embodiments, the relational database further stores third-party data from one or more third parties that are used to facilitate the transfer. The third-party data can include at least one selected from the group consisting of (i) market data, (ii) cost of living index data, (iii) census data, (iv) interest rate data, (v) industry data, (vi) government data, (vii) wireless data tower data, (viii) school enrollment data, (ix) weather data, (x) generalized resource transfer data, (xii) crime statistics; (xiii) social medial sentiment data, and (xiv) news related data.

At block 2615, the system initiates displaying, via the user computing device, the requested series of Create Work Flow GUIs to facilitate effectuation of the transfer.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A computing system for integrated platform graphical user interface customization, comprising at least one processor, a communication interface communicatively coupled to the at least one processor, and a memory device storing executable code that, when executed, causes the at least one processor to:
(a) initiate displaying, via a display of a user computing device, a first GUI of an integrated platform that interconnects one or more transfer sources and one or more transfer destinations, wherein access to the integrated platform is restricted to registered users;
(b) obtain end user data of at least one transfer destination of the one or more transfer destinations, wherein the end user data are at least partially obtained from user responses to system prompts displayed via the first GUI and also from user activities of one or more users of the at least one transfer destination;
(c) apply the end user data to a deployed neural network to identify one or more resources available for transfer from the one or more transfer sources to the one or more transfer destinations, wherein applying the end user data to the deployed neural network generates a listing of the one or more resources available;
(d) assign, based on the identified one or more resources, a priority score to each of the one or more resources, wherein the priority score indicates a likelihood that the one or more users of the at least one transfer destination will initiate a transfer of the one or more resources;
(e) sort the listing of the one or more resources in accordance with the assigned priority score such that highest scored resources are displayed first; and
(f) initiate displaying, via the display of the user computing device, a customized second GUI comprising the listing of the one or more resources.

2. The computing system of claim 1, wherein the end user data comprises end user account data, navigation data, system configuration data, and activity data.

3. The computing system of claim 1, wherein the end user data comprises end user account data, the end user account data including at least one selected from the group consisting of (i) a unique user identifier (ii) user domicile data, (iii) user contact data, (iv) user demographic data, (v) user occupational data, (vi) user household data, (vii) user residential data, (viii) user interest data, and (ix) end user role data.

4. The computing system of claim 1, wherein the end user data comprises navigation data, the navigation data including at least one selected from the group consisting of (i) navigation history data, (ii) redirect data, and (iii) search history data.

5. The computing system of claim 1, wherein the end user data comprises system configuration data, the system configuration data including at least one selected from the group consisting of (i) a unique identifier for the user computing device, (ii) a MAC address for a local network of the user computing device, (iii) copies of key system files that are unlikely to change between instances when a provider system is accessed, (iv) a list of applications running or installed on the user computing device, and (v) authentication data for authenticating the user computing device.

6. The computing system of claim 1, wherein:
(a) the end user data comprises activity data capture from activity data packets received from the user computing device;
(b) the activity data is generated by one or more software applications running on the user computing device; and
(c) the activity data including at least one selected from the group consisting of (i) time and date data, (ii) an event identifier of activity represented by event data; (iii) an event type indicating a category of activities represented by an event, (iv) an event source identifier identifying a software application or hardware device originating the activity data, (v) an endpoint identifier, and (vi) characterizing data characterizing the event.

7. The computing system of claim 1, wherein the executable code, when executed, further causes the at least one processor to:
(a) receive, from the user computing device, a request to access a listing GUI of a resource of the one or more resources; and
(b) initiate displaying, via the user computing device, the requested listing GUI, wherein the listing GUI depicts (i) fields for representing and receiving property data, annotation data, and multimedia content data, wherein the content data are selected from the group consisting of image data, audio data, and video data that characterize the resource of the listing GUI, (ii) listing status data, and (iii) contact information of one or more intermediaries associated with the resource.

8. The computing system of claim 1, wherein the executable code, when executed, further causes the at least one processor to:
(a) receive, from the user computing device, a request to access a workflow GUI that displays at least a partial workflow for transferring a resource of the one or more resources to the one or more transfer destinations from the one or more transfer sources; and
(b) initiate displaying, via the user computing device, the requested workflow GUI depicting an itemization of action items, action item status, and categories of the action items that are to be completed to effectuate transfer of the resource.

9. The computing system of claim 1, wherein the executable code, when executed, further causes the at least one processor to:
(a) receive, from the user computing device, a request to access a series of Create Work Flow GUIs used to initiate a work flow of a transfer of a resource of the one or more resources, the series of Create Work Flow GUIs facilitating data entry related to the transfer, wherein data to be entered via the Create Work Flow GUIs includes at least one selected from the group consisting of (i) a property address, (ii) a duration for completing the work flow, (iii) motivation data characterizing an underlying reason for initiating the transfer; and (iv) residential data characterizing the resource subject to the transfer; and
(b) initiate displaying, via the user computing device, the requested series of Create Work Flow GUIs.

10. The computing system of claim 9, wherein entered data provided via the data entry is stored to a relational database as transfer data, the transfer data including at least one selected from the group consisting of (i) a time and date to effectuate the transfer, (ii) a duration required to complete the work flow, (iii) a unique transfer identifier, (iv) a resource value of the resource, (v) identifying information of one or more transfer sources and the one or more transfer destinations, (vi) end user data, (vii) resource data characterizing the resource, (vii) category data characterizing the transfer, and (ix) annotation data.

11. The computing system of claim 1, wherein the executable code, when executed, further causes the at least one processor to generate one or more actionable insights to be distributed to at least one of the one or more transfer sources and one or more transfer destinations, wherein the one or more actionable insights are generated using actionable insight data that includes at least one selected from the group consisting of (i) transferring market conditions data indicating market conditions are favorable or unfavorable for a resource transfer of a resource associated with the one or more transfer sources, (ii) receiving resource market condition data indicating the market conditions are favorable or unfavorable for obtaining a new resource that matches end user preference data, and (iii) renovation market condition data indicating the market conditions are favorable or unfavorable for to renovate a resource of the one or more transfer sources.

12. The computing system of claim 1, wherein:
(a) executing the executable code further causes the processor to initiate displaying, via the display of the user computing device, a content posting published to a content notification data feed; and
(b) the content posting comprises the listing of the one or more resources.

13. The computing system of claim 1, wherein executing the executable code further causes the processor to initiate displaying, via the display of the user computing device, a targeted communication comprising the listing of the one or more resources.

14. The computing system of claim 1, wherein
(a) applying the end user data to the deployed neural network further identifies at least one feature for each of the one or more resources available and a probability score for each feature; and
(b) the customized second GUI further comprises the at least one feature for each of the one or more resources, wherein the at least one feature is displayed according to the probability score.

15. A computing system, comprising at least one processor, a communication interface communicatively coupled to the at least one processor and a memory device storing executable code that, when executed, causes the at least one processor to:
(a) obtain activity data generated by one or more user devices that are each operated by a transfer destination, wherein the activity data is generated by software application running on the one or more user computing devices;
(b) apply the activity data to Prioritization Module comprising one or more neural networks, wherein the Prioritization Module generates prioritized content data relating to features of an available resource;
(c) generate a targeted communication comprising the prioritized content data;
(d) transmit the prioritized content data and listing data to the user devices; and
(e) initiate displaying, via the display of the user computing device, a customized Graphical User Interface (GUI) comprising the listing data and the prioritized content data.

16. The computing system of claim 15, wherein the targeted communication is transmitted to the user computing devices through text message, email, push notifications, or notifications displayed within a mobile software application.

17. The computing system of claim 15, wherein the targeted communication comprises a content posting published to a content notification data feed.

18. A computing system comprising at least one processor and a memory device storing executable code that, when executed, causes the at least one processor to:
(a) load resource image data depicting at least part of an available resource;
(b) receive staging instructions input by a user; and
(c) use a virtual staging tool to apply the staging instructions to the resource image data, wherein the virtual staging tool (i) comprises one or more neural networks, and (ii) outputs annotated resource image data.

19. The computing system of claim 18, wherein the staging instructions (i) comprise text data or image data; and (ii) the staging instructions depict or describe design elements that comprise one or more surface paint colors, furniture, appliances, light fixtures, flooring, or structural elements.

20. The computing system of claim 18, wherein:
(a) virtual staging tool receives staging training data, wherein the training data comprises image data depicting design elements that comprise one or more surface paint colors, furniture, appliances, light fixtures, flooring, or structural elements;
(b) the neural networks process the staging training data to generate annotated resource image data;
(c) the annotated resource image data is compared against reference resource image data to generate error data; and
(d) the neural network comprises node parameters that are adjusted to minimize the error data.
